(19) United States
(12) Patent Application Publication
(10) Pub. No.: US 2022/0112391 A1
(43) Pub. Date: Apr. 14, 2022

(54) THERMAL TRANSFER RIBBONS AND DIRECT THERMAL PRINT MEDIA INCLUDING ENVIRONMENTAL EXPOSURE INDICATOR MATERIAL

(71) Applicant: Temptime Corporation, Morris Plains, NJ (US)

(72) Inventors: Marielle K. SMITH, Parlin, NJ (US); Mohannad Abdo, Clifton, NJ (US); John Olson, Dayton, NJ (US)

(73) Assignee: Temptime Corporation, Morris Plains, NJ (US)

(21) Appl. No.: 17/065,706

(22) Filed: Oct. 8, 2020

(51) Int. Cl. C09D 11/50; C09D 5/26; C09D 11/107; C09D 11/037; B41M 5/382

(52) U.S. Cl. CPC C09D 11/50; C09D 5/26; B41M 5/38214; C09D 11/037; C09D 11/107

(57) ABSTRACT

A label includes a flexible substrate comprising a first side and a second side. The first side is an adhesive, the second side is configured to be printed with a first visible mark, and the second side has a second printed, overlapping mark. The overlapping mark is configured to change opacity below a first transition temperature to obscure the visible mark.

### BACKGROUND

Printing systems include laser printers, thermal printers and dot matrix printers. Laser printers pass a laser beam over paper or a substrate. Inkjet printing involves a process of propelling droplets of ink onto paper or a substrate. Dot Matrix printers use a printer head that strikes an ink soaked ribbon, which then is pressed against paper or a substrate. Thermal transfer printing uses a heat-sensitive ribbon or thermal transfer ribbon and a thermal print head to apply the ink from the ribbon to the paper or substrate. Direct thermal printing is a digital printing process that produces a printed image without a ribbon. Direct thermal printing uses a chemically treated, heat-sensitive media that images (e.g., blackens) when it passes under the thermal print head. Both thermal transfer ribbons and direct thermal printing are used in tag and label applications to image various dataforms, such as images, readable text, barcode symbols etc. High resolution thermal print heads enable printing of more complex designs. Thermal transfer ribbons and direct thermal print media may be used for printing black and colored images.

### SUMMARY

The present disclosure provides a new and innovative system, methods and apparatus for thermal transfer ribbons and direct thermal media that includes environmental exposure indicator material, along with methods of making and using the thermal transfer ribbons and direct thermal media to print dataforms, such as barcode symbols. In an aspect of the present disclosure, an environmental exposure thermal paper prepared by a process comprising the steps of adding reversible thermochromic pigments to an acrylic binder and a water based solvent to create a reversible thermochromic formulation. The thermochromic formulation is configured to change color state from blue to colorless in response to temperature exposure above a threshold temperature of 18° C. The process also comprises the step of coating thermal paper with the reversible thermochromic formulation.

In another aspect of the present disclosure, which may be used in combination with any other aspect or combination of aspects listed herein, the acrylic binder is a clear, viscous acrylic resin solution.

In another aspect of the present disclosure, which may be used in combination with any other aspect or combination of aspects listed herein, the thermochromic formulation includes one of 26 weight percent of thermochromic pigments, 24.5 weight percent of thermochromic pigments, and 24 weight percent of thermochromic pigments.

In another aspect of the present disclosure, which may be used in combination with any other aspect or combination of aspects listed herein, the thermochromic formulation includes one of 44 weight percent of the acrylic binder, 47 weight percent of the acrylic binder, and 49 weight percent of the acrylic binder.

In another aspect of the present disclosure, which may be used in combination with any other aspect or combination of aspects listed herein, the thermochromic formulation has a viscosity (cps) between 150 cps and 300 cps.

In another aspect of the present disclosure, which may be used in combination with any other aspect or combination of aspects listed herein, the thermochromic formulation has a yield stress between 3.0 dyne/cm² and 17 dyne/cm².

Aspects of the subject matter described herein may be useful alone or in combination with one or more other aspects described herein. In an aspect of the present disclosure, an environmental exposure dataform prepared by a process comprising the steps of imaging a thermal paper with a dataform through at least one layer of a reversible thermochromic ink to create the environmental exposure dataform. The reversible thermochromic ink is configured to change color state from blue to colorless in response to temperature exposure above a threshold temperature of 18° C.

In another aspect of the present disclosure, which may be used in combination with any other aspect or combination of aspects listed herein, the reversible thermochromic ink is formed by mixing thermochromic pigments with an acrylic binder and a water based solvent.

In another aspect of the present disclosure, which may be used in combination with any other aspect or combination of aspects listed herein, the acrylic binder is a clear, viscous acrylic resin solution.

In another aspect of the present disclosure, which may be used in combination with any other aspect or combination of aspects listed herein, the thermochromic ink includes one of 26 weight percent of thermochromic pigments, 24.5 weight percent of thermochromic pigments, and 24 weight percent of thermochromic pigments.

In another aspect of the present disclosure, which may be used in combination with any other aspect or combination of aspects listed herein, the thermochromic ink includes one of 44 weight percent of the acrylic binder, 47 weight percent of the acrylic binder, and 49 weight percent of the acrylic binder.

In another aspect of the present disclosure, which may be used in combination with any other aspect or combination of aspects listed herein, the thermochromic ink has a viscosity (cps) between 150 cps and 300 cps.

In another aspect of the present disclosure, which may be used in combination with any other aspect or combination of aspects listed herein, the thermochromic ink has a yield stress between 3.0 dyne/cm² and 17 dyne/cm².

Aspects of the subject matter described herein may be useful alone or in combination with one or more other aspects described herein. In an aspect of the present disclosure, a label includes a flexible substrate comprising a first side and a second side. The first side is an adhesive, the second side is configured to be printed with a first visible mark, and the second side has a second printed, overlapping mark. The overlapping mark is configured to change opacity below a first transition temperature to obscure the visible mark.

In another aspect of the present disclosure, which may be used in combination with any other aspect or combination of aspects listed herein, the overlapping mark changes opacity from opaque to transparent at a second transition temperature, the second transition temperature being the same as the first transition temperature.

In another aspect of the present disclosure, which may be used in combination with any other aspect or combination of aspects listed herein, the overlapping mark changes from opaque to transparent at a second transition temperature, the second transition temperature being warmer than the first transition temperature.

In another aspect of the present disclosure, which may be used in combination with any other aspect or combination of aspects listed herein, the adhesive is configured to attach the label to a vial, and the second transition temperature is configured to change opacity when a liquid within the vial reaches 18° C.

In another aspect of the present disclosure, which may be used in combination with any other aspect or combination of aspects listed herein, the flexible substrate comprises a thermochromic layer configured to be printed by a thermal printer at an imaging temperature.

In another aspect of the present disclosure, which may be used in combination with any other aspect or combination of aspects listed herein, the flexible substrate comprises a top coating configured to be printed by a thermal printer.

In another aspect of the present disclosure, which may be used in combination with any other aspect or combination of aspects listed herein, the visible mark is light blue and the overlapping mark, when opaque, is dark blue.

In another aspect of the present disclosure, which may be used in combination with any other aspect or combination of aspects listed herein, the flexible substrate is a thermal paper substrate configured to be printed by a direct thermal print process with a heated thermal print head, the thermal paper substrate having an imaging temperature and adapted to change color when heated by the heated thermal print head to or above the imaging temperature.

In another aspect of the present disclosure, which may be used in combination with any other aspect or combination of aspects listed herein, the label further includes an environmental exposure indicator provided on the thermal paper substrate, the environmental exposure indicator comprising an environmental exposure indicator material configured to change color state in response to a temperature exposure above a predetermined threshold temperature, which is below the imaging temperature.

In another aspect of the present disclosure, which may be used in combination with any other aspect or combination of aspects listed herein, the environmental exposure indicator is the overlapping mark.

In another aspect of the present disclosure, which may be used in combination with any other aspect or combination of aspects listed herein, the environmental exposure indicator material is a dye encapsulated in a matrix.

In another aspect of the present disclosure, which may be used in combination with any other aspect or combination of aspects listed herein, the environmental exposure indicator material is selected from the group consisting of (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold; and (e) an irreversible thermochromic indicator material configured to change color state responsive to cumulative heat exposure over time.

In another aspect of the present disclosure, which may be used in combination with any other aspect or combination of aspects listed herein, the group further consists of (f) an indicator material configured to change color state responsive to exposure to radiation, (g) an indicator material configured to change color state responsive to exposure to light of a predetermined wavelength, and (h) an indicator material configured to change color state responsive to exposure to humidity.

In another aspect of the present disclosure, which may be used in combination with any other aspect or combination of aspects listed herein, the environmental exposure indicator material is (a), and the flexible substrate is configured for imaging a dataform, preferably a barcode, on the flexible substrate at an imaging temperature above the threshold temperature without the environmental exposure indicator material changing color state.

In another aspect of the present disclosure, which may be used in combination with any other aspect or combination of aspects listed herein, the dataform is the visible mark.

In another aspect of the present disclosure, which may be used in combination with any other aspect or combination of aspects listed herein, the environmental exposure indicator material is (a), and the environmental exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In another aspect of the present disclosure, which may be used in combination with any other aspect or combination of aspects listed herein, the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the threshold temperature is one of 35° C., 40° C., 45° C., 50° C. and 60° C.

In another aspect of the present disclosure, which may be used in combination with any other aspect or combination of aspects listed herein, the threshold temperature is 40° C.

In another aspect of the present disclosure, which may be used in combination with any other aspect or combination of aspects listed herein, the print head has a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

The print head is configured to heat at least a portion of the label to a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the environmental exposure indicator material further comprises a leuco dye, a micro-encapsulated leuco-dye, an SCC Polymer, a water-based SCC polymer emulsion, a diacetylene, an alkane, a wax, an ester or combinations thereof.

In another aspect of the present disclosure, which may be used in combination with any other aspect or combination of aspects listed herein, the environmental exposure indicator material has a particle size in the range selected from the group consisting of about 0.1 to 15 microns, about 0.1 to 10 microns, about 0.4 to 10 microns, about 0.4 to 10 microns, about 5 to 10 microns, about 6 to 10 microns, about 7 to 10 microns, about 8 to 10 microns, about 9 to 10 microns, about 1 to 9 microns, about 1 to 8 microns, about 1 to 7 microns, about 1 to 6 microns, about 1 to 5 microns, about 1 to 4 microns, about 1 to 3 microns, about 1 to 2 microns, about 3 to 7 microns, about 3 to 6 microns, about 3 to 5 microns, about 4 to 7 microns, and about 4 to 6 microns.

In another aspect of the present disclosure, which may be used in combination with any other aspect or combination of aspects listed herein, the environmental exposure indicator material has a particle size between 400 nm and 600 nm.

In another aspect of the present disclosure, which may be used in combination with any other aspect or combination of aspects listed herein, the environmental exposure indicator material has a concentration, in a layer applied to the direct thermal printer stock, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

In another aspect of the present disclosure, which may be used in combination with any other aspect or combination of aspects listed herein, the environmental exposure indicator material is (c), and the second lower temperature threshold is in the range selected from the group consisting of <4° C., <0° C., <−5° C., <−10° C. and <−15° C.

In another aspect of the present disclosure, which may be used in combination with any other aspect or combination of aspects listed herein, the environmental exposure indicator material is provided on the thermal paper substrate as an ink slurry.

In another aspect of the present disclosure, which may be used in combination with any other aspect or combination of aspects listed herein, the ink slurry is provided on the thermal paper substrate in a layer having a thickness of 1.5 mil when wet.

In another aspect of the present disclosure, which may be used in combination with any other aspect or combination of aspects listed herein, the ink slurry is configured to change color state from black to colorless above the threshold temperature of 55° C., and to maintain the changed color state until the temperature falls below a second lower temperature threshold of 0° C.

In another aspect of the present disclosure, which may be used in combination with any other aspect or combination of aspects listed herein, the ink slurry is configured to change color state from colorless to black above the threshold temperature of 65° C.

In another aspect of the present disclosure, which may be used in combination with any other aspect or combination of aspects listed herein, the ink slurry is configured to change color state from colorless to magenta above the threshold temperature of 85° C.

In another aspect of the present disclosure, which may be used in combination with any other aspect or combination of aspects listed herein, the environmental exposure indicator material is provided on the thermal paper substrate as an SCC emulsion.

In another aspect of the present disclosure, which may be used in combination with any other aspect or combination of aspects listed herein, the SCC emulsion is provided on the thermal paper substrate in a layer having a thickness of 1.5 mil when wet.

In another aspect of the present disclosure, which may be used in combination with any other aspect or combination of aspects listed herein, the SCC emulsion is configured to change color state from opaque white to colorless above the threshold temperature of 40° C.

Aspects of the subject matter described herein may be useful alone or in combination with one or more other aspects described herein. In an aspect of the present disclosure, an environmental exposure thermal transfer ribbon is prepared by a process comprising the steps of adding reversible thermochromic pigments to an acrylic binder and an IPA solvent matrix to create a reversible thermochromic formulation. The thermochromic formulation is configured to change color state from black to colorless in response to temperature exposure above a threshold temperature of 35° C. The process also includes coating a blank thermal transfer ribbon with the reversible thermochromic formulation.

Aspects of the subject matter described herein may be useful alone or in combination with one or more other aspects described herein. In an aspect of the present disclosure, an environmental exposure dataform is prepared by a process comprising the steps of performing a thermal print operation on a thermal transfer ribbon to print a dataform on a print media, thereby creating the environmental exposure dataform, the thermal transfer ribbon including a layer of a reversible thermochromic formulation. The thermochromic formulation is configured to change color state from black to colorless in response to temperature exposure above a threshold temperature of 35° C.

In another aspect of the present disclosure, which may be used in combination with any other aspect or combination of aspects listed herein, the reversible thermochromic formulation includes reversible thermochromic pigments, an acrylic binder, and an IPA solvent matrix.

Aspects of the subject matter described herein may be useful alone or in combination with one or more other aspects described herein. In an aspect of the present disclosure, an environmental exposure thermal transfer ribbon is prepared by a process comprising the steps of adding reversible thermochromic pigments to an acrylic binder and an IPA solvent matrix to create a reversible thermochromic formulation. The thermochromic formulation is configured to change color state from blue to colorless in response to temperature exposure above a threshold temperature of 12° C. The process also includes coating a blank thermal transfer ribbon with the reversible thermochromic formulation.

Aspects of the subject matter described herein may be useful alone or in combination with one or more other aspects described herein. In an aspect of the present disclosure, an environmental exposure dataform is prepared by a process comprising the steps of performing a thermal print operation on a thermal transfer ribbon to print a dataform on a print media, thereby creating the environmental exposure dataform. The thermal transfer ribbon includes a layer of a reversible thermochromic formulation. The thermochromic formulation is configured to change color state from blue to colorless in response to temperature exposure above a threshold temperature of 12° C.

In another aspect of the present disclosure, which may be used in combination with any other aspect or combination of aspects listed herein, the reversible thermochromic formulation includes reversible thermochromic pigments, an acrylic binder, and an IPA solvent matrix.

Aspects of the subject matter described herein may be useful alone or in combination with one or more other aspects described herein. In an aspect of the present disclosure, an environmental exposure thermal paper is prepared by a process comprising the steps of coating thermal paper with at least one layer of a semi-reversible thermochromic ink slurry. The at least one layer has a thickness of 1.5 mil when wet. Additionally, the semi-reversible thermochromic ink slurry is configured to change color state from black to colorless above a threshold temperature of 55° C., and to maintain the changed color state until the temperature falls below a second lower temperature threshold of 0° C.

Aspects of the subject matter described herein may be useful alone or in combination with one or more other aspects described herein. In an aspect of the present disclosure, an environmental exposure dataform is prepared by a process comprising the steps of imaging a thermal paper with a dataform through at least one layer of a semi-reversible thermochromic ink to create the environmental exposure dataform. The semi-reversible thermochromic ink is configured to change color state from black to colorless above a threshold temperature of 55° C., and to maintain the changed color state until the temperature falls below a second lower temperature threshold of 0° C. The imaging process is unaffected by at least one layer of the semi-reversible thermochromic ink.

In another aspect of the present disclosure, which may be used in combination with any other aspect or combination of aspects listed herein, the at least one layer of the semi reversible thermochromic ink is coated on the thermal paper as a semi-reversible thermochromic ink slurry. The at least one layer has a thickness of 1.5 mil when wet.

Aspects of the subject matter described herein may be useful alone or in combination with one or more other aspects described herein. In an aspect of the present disclosure, an environmental exposure thermal paper is prepared by a process comprising the steps of coating thermal paper with at least one layer of an irreversible thermochromic ink slurry. The at least one layer has a thickness of 1.5 mil when wet, and the irreversible thermochromic ink slurry is configured to change color state from colorless to black above a threshold temperature of 65° C.

Aspects of the subject matter described herein may be useful alone or in combination with one or more other aspects described herein. In an aspect of the present disclosure, an environmental exposure dataform is prepared by a process comprising the steps of imaging a thermal paper with a dataform through at least one layer of an irreversible thermochromic ink to create the environmental exposure dataform. The irreversible thermochromic ink is configured to change color state from colorless to black above a threshold temperature of 65° C. The imaging process is unaffected by at least one layer of the irreversible thermochromic ink.

In another aspect of the present disclosure, which may be used in combination with any other aspect or combination of aspects listed herein, the at least one layer of the irreversible thermochromic ink is coated on the thermal paper as an irreversible thermochromic ink slurry. The at least one layer has a thickness of 1.5 mil when wet.

Aspects of the subject matter described herein may be useful alone or in combination with one or more other aspects described herein. In an aspect of the present disclosure, an environmental exposure thermal paper is prepared by a process comprising the steps of coating thermal paper with at least one layer of an irreversible thermochromic ink slurry. The layer has a thickness of 1.5 mil when wet, and the irreversible thermochromic ink slurry is configured to change color state from colorless to magenta above a threshold temperature of 85° C.

Aspects of the subject matter described herein may be useful alone or in combination with one or more other aspects described herein. In an aspect of the present disclosure, an environmental exposure dataform is prepared by a process comprising the steps of imaging a thermal paper with a dataform through at least one layer of an irreversible thermochromic ink to create the environmental exposure dataform. The irreversible thermochromic ink is configured to change color state from colorless to magenta above a threshold temperature of 85° C. The imaging process is unaffected by at least one layer of the irreversible thermochromic ink.

In another aspect of the present disclosure, which may be used in combination with any other aspect or combination of aspects listed herein, the at least one layer of the irreversible thermochromic ink is coated on the thermal paper as an irreversible thermochromic ink slurry. The at least one layer has a thickness of 1.5 mil when wet.

Aspects of the subject matter described herein may be useful alone or in combination with one or more other aspects described herein. In an aspect of the present disclosure, an environmental exposure thermal paper is prepared by a process comprising the steps of coating thermal paper with a layer of an SCC emulsion. The layer has a thickness of 1.5 mil when wet, and the SCC emulsion is configured to change color state from opaque white to colorless in response to temperature exposure above a threshold temperature of 40° C.

In another aspect of the present disclosure, which may be used in combination with any other aspect or combination of aspects listed herein, the thermal paper is black flood printed prior to being coated with the layer of the SCC emulsion.

Aspects of the subject matter described herein may be useful alone or in combination with one or more other aspects described herein. In an aspect of the present disclosure, an environmental exposure dataform is prepared by a process comprising the steps of imaging a thermal paper with a dataform through a layer of a SCC emulsion to create the environmental exposure dataform. The SCC emulsion is configured to change color state from opaque white to colorless in response to temperature exposure above a threshold temperature of 40° C. Additionally, the imaging process is unaffected by the layer of the SCC emulsion.

In another aspect of the present disclosure, which may be used in combination with any other aspect or combination of aspects listed herein, the SCC emulsion is coated on the thermal paper to form the layer, and the layer has a thickness of 1.5 mil when wet.

Aspects of the subject matter described herein may be useful alone or in combination with one or more other aspects described herein. In an aspect of the present disclosure, a direct thermal printer stock, which includes an environmental exposure indicator material, also includes a thermal paper substrate configured to be printed by a direct thermal print process with a heated thermal print head. The thermal paper substrate has an imaging temperature and is adapted to change color when heated by the heated thermal print head to or above the print temperature. The direct thermal printer stock also includes an environmental exposure indicator provided on the thermal paper substrate. The temperature exposure indicator includes the environmental exposure indicator material, which is configured to change color state in response to a temperature exposure above a predetermined threshold temperature, which is below the print temperature.

In another aspect of the present disclosure, which may be used in combination with any other aspect or combination of aspects listed herein, the environmental exposure indicator material is a dye encapsulated in a matrix.

In another aspect of the present disclosure, which may be used in combination with any other aspect or combination of aspects listed herein, the environmental exposure indicator material is selected from the group consisting of: (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the group further consists of: (f) an indicator material configured to change color state responsive to exposure to radiation, (g) an indicator material configured to change color state responsive to exposure to light of a predetermined wavelength, and (h) an indicator material configured to change color state responsive to exposure to humidity.

In another aspect of the present disclosure, which may be used in combination with any other aspect or combination of aspects listed herein, the environmental exposure indicator material is (a), and the direct thermal printer stock is configured for imaging a dataform, preferably a barcode, on the direct thermal printer stock at a print temperature above the threshold temperature without the environmental exposure indicator material changing color state.

In another aspect of the present disclosure, which may be used in combination with any other aspect or combination of aspects listed herein, the environmental exposure indicator material is (a), and the environmental exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In another aspect of the present disclosure, which may be used in combination with any other aspect or combination of aspects listed herein, the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the threshold temperature is one of 35° C., 40° C., 45° C., 50° C. and 60° C.

In another aspect of the present disclosure, which may be used in combination with any other aspect or combination of aspects listed herein, the threshold temperature is 40° C.

In another aspect of the present disclosure, which may be used in combination with any other aspect or combination of aspects listed herein, the print head has a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the print head is configured to heat at least a portion of the direct thermal printer stock to a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the environmental exposure indicator material further comprises a leuco dye, a micro-encapsulated leuco-dye, an SCC Polymer, a water-based SCC polymer emulsion, a diacetylene, an alkane, a wax, an ester or combinations thereof.

In another aspect of the present disclosure, which may be used in combination with any other aspect or combination of aspects listed herein, the environmental exposure indicator material has a particle size in the range selected from the group consisting of about 0.1 to 15 microns, about 0.1 to 10 microns, about 0.4 to 10 microns, about 0.4 to 10 microns, about 5 to 10 microns, about 6 to 10 microns, about 7 to 10 microns, about 8 to 10 microns, about 9 to 10 microns, about 1 to 9 microns, about 1 to 8 microns, about 1 to 7 microns, about 1 to 6 microns, about 1 to 5 microns, about 1 to 4 microns, about 1 to 3 microns, about 1 to 2 microns, about 3 to 7 microns, about 3 to 6 microns, about 3 to 5 microns, about 4 to 7 microns, and about 4 to 6 microns.

In another aspect of the present disclosure, which may be used in combination with any other aspect or combination of aspects listed herein, the environmental exposure indicator material has a particle size between 400 nm and 600 nm.

In another aspect of the present disclosure, which may be used in combination with any other aspect or combination of aspects listed herein, the environmental exposure indicator material has a concentration, in a layer applied to the direct thermal printer stock, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

In another aspect of the present disclosure, which may be used in combination with any other aspect or combination of aspects listed herein, the environmental exposure indicator material is (c) and the second lower temperature threshold is in the range selected from the group consisting of <4° C., <0° C., <−5° C., <−10° C. and <−15° C.

In another aspect of the present disclosure, which may be used in combination with any other aspect or combination of aspects listed herein, the environmental exposure indicator material is provided on the thermal paper substrate as an ink slurry.

In another aspect of the present disclosure, which may be used in combination with any other aspect or combination of aspects listed herein, the ink slurry is provided on the thermal paper substrate in a layer having a thickness of 1.5 mil when wet.

In another aspect of the present disclosure, which may be used in combination with any other aspect or combination of aspects listed herein, the ink slurry is configured to change color state from black to colorless above the threshold temperature of 55° C., and to maintain the changed color state until the temperature falls below a second lower temperature threshold of 0° C.

In another aspect of the present disclosure, which may be used in combination with any other aspect or combination of aspects listed herein, the environmental exposure indicator material is provided on the thermal paper substrate as an ink slurry.

In another aspect of the present disclosure, which may be used in combination with any other aspect or combination of aspects listed herein, the ink slurry is provided on the thermal paper substrate in a layer having a thickness of 1.5 mil when wet.

In another aspect of the present disclosure, which may be used in combination with any other aspect or combination of aspects listed herein, the ink slurry is configured to change color state from colorless to black above the threshold temperature of 65° C.

In another aspect of the present disclosure, which may be used in combination with any other aspect or combination of aspects listed herein, the ink slurry is configured to change color state from colorless to magenta above the threshold temperature of 85° C.

In another aspect of the present disclosure, which may be used in combination with any other aspect or combination of aspects listed herein, the environmental exposure indicator material is provided on the thermal paper substrate as an SCC emulsion.

In another aspect of the present disclosure, which may be used in combination with any other aspect or combination of aspects listed herein, the SCC emulsion is provided on the thermal paper substrate in a layer having a thickness of 1.5 mil when wet.

In another aspect of the present disclosure, which may be used in combination with any other aspect or combination of aspects listed herein, the SCC emulsion is configured to change color state from opaque white to colorless above the threshold temperature of 40° C.

Aspects of the subject matter described herein may be useful alone or in combination with one or more other aspects described herein. In an aspect of the present disclosure, a thermal transfer ribbon includes a backing substrate, a temperature threshold exposure indicator material configured to change color state in response to temperature exposure above or below a threshold temperature, and a binding layer. The binding layer is positioned to couple the temperature exposure indicator material to the backing substrate and is configured to release the temperature exposure indicator material to a printable media when heated by a print head. Additionally, the binding layer has a melt temperature higher than the threshold temperature and has a stronger adhesion to the print media than the binding layer's adhesion to the backing substrate.

In another aspect of the present disclosure, which may be used in combination with any other aspect or combination of aspects listed herein, the thermal transfer ribbon further includes a release coating coupling the binding layer to the backing substrate.

In another aspect of the present disclosure, which may be used in combination with any other aspect or combination of aspects listed herein, the release coating is a heat-responsive wax.

In another aspect of the present disclosure, which may be used in combination with any other aspect or combination of aspects listed herein, the temperature threshold exposure indicator material is selected from the group consisting of (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the temperature threshold exposure indicator material is (a), and the temperature threshold exposure indicator material is configured to be applied to the print media when the binding layer melted by the print head having a printing temperature above the melt temperature without the temperature threshold exposure indicator material changing color state.

In another aspect of the present disclosure, which may be used in combination with any other aspect or combination of aspects listed herein, the temperature threshold exposure indicator material is (a), and the temperature threshold exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In another aspect of the present disclosure, which may be used in combination with any other aspect or combination of aspects listed herein, the backing substrate is selected from the group consisting of polyester, polyethylene, paper, printable polyethylene terephthalate (“PET”), oriented polypropylene (“OPP”), and combinations thereof.

In another aspect of the present disclosure, which may be used in combination with any other aspect or combination of aspects listed herein, the binding layer includes an adhesive that is solvent based, aqueous emulsion based, or water soluble.

In another aspect of the present disclosure, which may be used in combination with any other aspect or combination of aspects listed herein, the adhesive includes at least one material selected from the group consisting of an aqueous emulsion adhesive, an acrylic polymer or co-polymer, an amine salt of an acrylic co-polymer, a carnauba wax, a candelilla wax, a hydrocarbon wax, Neocryl A-1052, Neocryl BT-24, Neocryl B-818, Epotuf 91-263, Ottopol 25-50E, Ottopol 25-30, Joncryl 682, and Joncryl 538A.

In another aspect of the present disclosure, which may be used in combination with any other aspect or combination of aspects listed herein, the adhesive has a melt temperature that is in the range selected from the group consisting of about 50 to 110° C., about 60 to 110° C., about 70 to 110° C., about 80 to 110° C., about 90 to 110° C., about 100 to 110° C., about 50 to 100° C., about 60 to 100° C., about 70 to 100° C., about 80 to 100° C., about 90 to 100° C., about 70 to 90° C., and about 80 to 90° C.

In another aspect of the present disclosure, which may be used in combination with any other aspect or combination of aspects listed herein, the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the threshold temperature is one of 35° C., 40° C., 45° C., 50° C. and 60° C.

In another aspect of the present disclosure, which may be used in combination with any other aspect or combination of aspects listed herein, the threshold temperature is 40° C.

In another aspect of the present disclosure, which may be used in combination with any other aspect or combination of aspects listed herein, the print head has a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the print head is configured to heat at least a portion of the thermal transfer ribbon to a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the temperature threshold exposure indicator material further comprises a leuco dye, a micro-encapsulated leuco-dye, an SCC Polymer, a water-based SCC polymer emulsion, a diacetylene, an alkane, a wax, an ester or combinations thereof.

In another aspect of the present disclosure, which may be used in combination with any other aspect or combination of aspects listed herein, the temperature threshold exposure indicator material has a particle size in the range selected from the group consisting of about 0.1 to 15 microns, about 0.1 to 10 microns, about 0.4 to 10 microns, about 0.4 to 10 microns, about 5 to 10 microns, about 6 to 10 microns, about 7 to 10 microns, about 8 to 10 microns, about 9 to 10 microns, about 1 to 9 microns, about 1 to 8 microns, about 1 to 7 microns, about 1 to 6 microns, about 1 to 5 microns, about 1 to 4 microns, about 1 to 3 microns, about 1 to 2 microns, about 3 to 7 microns, about 3 to 6 microns, about 3 to 5 microns, about 4 to 7 microns, and about 4 to 6 microns.

In another aspect of the present disclosure, which may be used in combination with any other aspect or combination of aspects listed herein, the temperature threshold exposure indicator material has a particle size between 400 nm and 600 nm.

In another aspect of the present disclosure, which may be used in combination with any other aspect or combination of aspects listed herein, the temperature threshold exposure indicator material has a concentration, in the binding layer, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

In another aspect of the present disclosure, which may be used in combination with any other aspect or combination of aspects listed herein, the substrate has a thickness from about 4 microns to about 6 microns.

In another aspect of the present disclosure, which may be used in combination with any other aspect or combination of aspects listed herein, the binding layer has a thickness from about 2 microns to about 50 microns.

In another aspect of the present disclosure, which may be used in combination with any other aspect or combination of aspects listed herein, the temperature threshold exposure indicator material is (c), and the second lower temperature threshold is in the range selected from the group consisting of <4° C., <0° C., <−5° C., <−10° C. and <−15° C.

In another aspect of the present disclosure, which may be used in combination with any other aspect or combination of aspects listed herein, the binding layer includes at least one additive configured to increase the heat capacity of the binding layer.

In another aspect of the present disclosure, which may be used in combination with any other aspect or combination of aspects listed herein, the binding layer include a plasticizer from the group consisting of: glycerol, propylene glycol, polyethylene glycol (“PEG”), phthalate ester, dibutyl sebacate, citrate ester, and triacetin.

In another aspect of the present disclosure, which may be used in combination with any other aspect or combination of aspects listed herein, the temperature threshold exposure indicator material is (a) and does not change color state when released to the printable media.

In another aspect of the present disclosure, which may be used in combination with any other aspect or combination of aspects listed herein, a portion of the biding layer is configured to release from the backing substrate to the printable media where the portion is heated by a heating element of the print head.

In another aspect of the present disclosure, which may be used in combination with any other aspect or combination of aspects listed herein, the temperature threshold exposure indicator material is configured to change color state from black to colorless in response to temperature exposure above the threshold temperature of 35° C.

In another aspect of the present disclosure, which may be used in combination with any other aspect or combination of aspects listed herein, the binding layer is formed from an acrylic binder and an IPA solvent matrix.

In another aspect of the present disclosure, which may be used in combination with any other aspect or combination of aspects listed herein, the backing substrate is a blank thermal transfer ribbon.

In another aspect of the present disclosure, which may be used in combination with any other aspect or combination of aspects listed herein, the temperature threshold exposure indicator material is configured to change color state from blue to colorless in response to temperature exposure above the threshold temperature of 12° C.

In another aspect of the present disclosure, which may be used in combination with any other aspect or combination of aspects listed herein, the binding layer is formed from an acrylic binder and an IPA solvent matrix.

In another aspect of the present disclosure, which may be used in combination with any other aspect or combination of aspects listed herein, the backing substrate is a blank thermal transfer ribbon.

Aspects of the subject matter described herein may be useful alone or in combination with one or more other aspects described herein. In an aspect of the present disclosure, a direct thermal label includes a thermal paper substrate configured to be printed by a direct thermal print process with a heated thermal print head. The thermal paper substrate has a print temperature and is adapted to change color when heated by the heated thermal print head to or above the print temperature. The direct thermal label also includes a temperature exposure indicator provided on the thermal paper substrate. The temperature exposure indicator includes the temperature exposure indicator material, which is configured to change color state in response to a temperature exposure above a predetermined threshold temperature, which is below the print temperature. Additionally, the direct thermal label includes a dataform imaged on the thermal paper substrate at or above the print temperature without the temperature exposure indicator material changing color state.

In another aspect of the present disclosure, which may be used in combination with any other aspect or combination of aspects listed herein, the temperature exposure indicator material is a dye encapsulated in a matrix.

In another aspect of the present disclosure, which may be used in combination with any other aspect or combination of aspects listed herein, the temperature exposure indicator material is selected from the group consisting of: (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the group further consists of: (f) an indicator material configured to change color state responsive to exposure to radiation, (g) an indicator material configured to change color state responsive to exposure to light of a predetermined wavelength, and (h) an indicator material configured to change color state responsive to exposure to humidity.

In another aspect of the present disclosure, which may be used in combination with any other aspect or combination of aspects listed herein, the temperature exposure indicator is configured to reveal a barcode symbol in response to a temperature exposure above the predetermined threshold temperature.

In another aspect of the present disclosure, which may be used in combination with any other aspect or combination of aspects listed herein, the temperature exposure indicator is configured to mask the barcode symbol in response to a temperature exposure below the predetermined threshold temperature.

In another aspect of the present disclosure, which may be used in combination with any other aspect or combination of aspects listed herein, the temperature exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In another aspect of the present disclosure, which may be used in combination with any other aspect or combination of aspects listed herein, the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the threshold temperature is one of 35° C., 40° C., 45° C., 50° C. and 60° C.

In another aspect of the present disclosure, which may be used in combination with any other aspect or combination of aspects listed herein, the threshold temperature is 40° C.

Aspects of the subject matter described herein may be useful alone or in combination with one or more other aspects described herein. In an aspect of the present disclosure, a label is configured to indicate temperature exposure above a threshold temperature. The label includes a substrate with a first side and a second side, the first side includes a printable area and an irreversible thermochromic indicator material configured to change color state in response to exposure to a temperature above the threshold temperature. The label also includes an adhesive layer adjacent the second side, and a coating layer adjacent the first side. The indicator material is between the coating layer and the substrate.

In another aspect of the present disclosure, which may be used in combination with any other aspect or combination of aspects listed herein, the printable area comprises a direct thermochromic material.

In another aspect of the present disclosure, which may be used in combination with any other aspect or combination of aspects listed herein, the coating layer is a resin of a thermal transfer ribbon.

In another aspect of the present disclosure, which may be used in combination with any other aspect or combination of aspects listed herein, the coating layer is a thermally printed overcoat.

In another aspect of the present disclosure, which may be used in combination with any other aspect or combination of aspects listed herein, the coating is a varnish.

In another aspect of the present disclosure, which may be used in combination with any other aspect or combination of aspects listed herein, the printable area comprises the irreversible thermochromic indicator material.

Aspects of the subject matter described herein may be useful alone or in combination with one or more other aspects described herein. In an aspect of the present disclosure, a method of manufacturing a thermal transfer ribbon includes providing a backing substrate, providing a temperature exposure indicator material configured to change color state in response to temperature exposure above a threshold temperature, and coupling the temperature exposure indicator material to the backing substrate with a binding layer. The binding layer is configured to release the temperature exposure indicator material to a printable media when heated by a print head. The binding layer has a melt temperature higher than the threshold temperature.

In another aspect of the present disclosure, which may be used in combination with any other aspect or combination of aspects listed herein, the thermal transfer ribbon is configured such that when the thermal transfer ribbon is heated by the print head of a thermal printer on a side of the backing substrate opposite the temperature exposure indicator material, so as to melt the binding layer, the temperature indicator material is released from the backing substrate and applied to the printable media.

In another aspect of the present disclosure, which may be used in combination with any other aspect or combination of aspects listed herein, the method further includes providing a release coating coupling the binding layer to the backing substrate, and coating the backing substrate with the release coating before coating the backing ribbon with the binding layer. The release coating is configured to couple the binding layer to the backing ribbon.

In another aspect of the present disclosure, which may be used in combination with any other aspect or combination of aspects listed herein, the release coating is a heat-responsive wax.

In another aspect of the present disclosure, which may be used in combination with any other aspect or combination of aspects listed herein, the temperature exposure indicator material is selected from the group consisting of: (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the temperature exposure indicator material is (a), and the temperature exposure indicator material is configured to be applied to the print media when the binding layer is melted by the print head having a printing temperature above the melt temperature without the temperature exposure indicator material changing color state.

In another aspect of the present disclosure, which may be used in combination with any other aspect or combination of aspects listed herein, the temperature exposure indicator material is (a), and the temperature exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In another aspect of the present disclosure, which may be used in combination with any other aspect or combination of aspects listed herein, the backing substrate is selected from the group consisting of polyester, polyethylene, paper, printable polyethylene terephthalate (“PET”), oriented polypropylene (“OPP”), and combinations thereof.

In another aspect of the present disclosure, which may be used in combination with any other aspect or combination of aspects listed herein, the binding layer includes an adhesive that is solvent based, aqueous emulsion based, or water soluble.

In another aspect of the present disclosure, which may be used in combination with any other aspect or combination of aspects listed herein, the adhesive includes at least one material selected from the group consisting of an aqueous emulsion adhesive, an acrylic polymer or co-polymer, an amine salt of an acrylic co-polymer, a carnauba wax, a candelilla wax, a hydrocarbon wax, Neocryl A-1052, Neocryl BT-24, Neocryl B-818, Epotuf 91-263, Ottopol 25-50E, Ottopol 25-30, Joncryl 682, and Joncryl 538A.

In another aspect of the present disclosure, which may be used in combination with any other aspect or combination of aspects listed herein, the adhesive has a melt temperature that is in the range selected from the group consisting of about 50 to 110° C., about 60 to 110° C., about 70 to 110° C., about 80 to 110° C., about 90 to 110° C., about 100 to 110° C., about 50 to 100° C., about 60 to 100° C., about 70 to 100° C., about 80 to 100° C., about 90 to 100° C., about 70 to 90° C., and about 80 to 90° C.

In another aspect of the present disclosure, which may be used in combination with any other aspect or combination of aspects listed herein, the method further includes dissolving the adhesive and the temperature exposure indicator material in a solvent to form a solution, applying the solution to the backing substrate, and drying the solution to form the binding layer.

In another aspect of the present disclosure, which may be used in combination with any other aspect or combination of aspects listed herein, the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the threshold temperature is one of 35° C., 40° C., 45° C., 50° C. and 60° C.

In another aspect of the present disclosure, which may be used in combination with any other aspect or combination of aspects listed herein, the threshold temperature is 40° C.

In another aspect of the present disclosure, which may be used in combination with any other aspect or combination of aspects listed herein, the print head has a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the print head is configured to heat at least a portion of the thermal transfer ribbon to a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the temperature exposure indicator material further comprises a leuco dye, a micro-encapsulated leuco-dye, an SCC Polymer, a water-based SCC polymer emulsion, a diacetylene, an alkane, a wax, an ester or combinations thereof.

In another aspect of the present disclosure, which may be used in combination with any other aspect or combination of aspects listed herein, the temperature exposure indicator material has a particle size in the range selected from the group consisting of about 0.1 to 15 microns, about 0.1 to 10 microns, about 0.4 to 10 microns, about 0.4 to 10 microns, about 5 to 10 microns, about 6 to 10 microns, about 7 to 10 microns, about 8 to 10 microns, about 9 to 10 microns, about 1 to 9 microns, about 1 to 8 microns, about 1 to 7 microns, about 1 to 6 microns, about 1 to 5 microns, about 1 to 4 microns, about 1 to 3 microns, about 1 to 2 microns, about 3 to 7 microns, about 3 to 6 microns, about 3 to 5 microns, about 4 to 7 microns, and about 4 to 6 microns.

In another aspect of the present disclosure, which may be used in combination with any other aspect or combination of aspects listed herein, the temperature exposure indicator material has a particle size between 400 nm and 600 nm.

In another aspect of the present disclosure, which may be used in combination with any other aspect or combination of aspects listed herein, the temperature exposure indicator material has a concentration, in the binding layer, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

In another aspect of the present disclosure, which may be used in combination with any other aspect or combination of aspects listed herein, the substrate has a thickness from about 4 microns to about 6 microns.

In another aspect of the present disclosure, which may be used in combination with any other aspect or combination of aspects listed herein, the binding layer has a thickness from about 2 microns to about 50 microns.

In another aspect of the present disclosure, which may be used in combination with any other aspect or combination of aspects listed herein, the temperature exposure indicator material is (c) and the second lower temperature threshold is in the range selected from the group consisting of <4° C., <0° C., <−5° C., <−10° C. and <−15° C.

In another aspect of the present disclosure, which may be used in combination with any other aspect or combination of aspects listed herein, the binding layer includes at least one additive configured to increase the heat capacity of the binding layer.

In another aspect of the present disclosure, which may be used in combination with any other aspect or combination of aspects listed herein, the binding layer include a plasticizer from the group consisting of: glycerol, propylene glycol, polyethylene glycol (“PEG”), phthalate ester, dibutyl sebacate, citrate ester, and triacetin.

Aspects of the subject matter described herein may be useful alone or in combination with one or more other aspects described herein. In an aspect of the present disclosure, a method for use with a thermal transfer ribbon having a backing substrate and a temperature exposure indicator material coupled to the substrate via a binding layer includes receiving a layout of a temperature indicator. The temperature indicator is to be formed by the temperature exposure indicator material of the binding layer, and the temperature exposure indicator material is configured to change color state in response to a temperature exposure above or below a predetermined threshold temperature. The method also includes heating the binding layer with a print head to a respective temperature at or above a melt temperature of the binding layer, thereby causing the binding layer to transfer from the thermal transfer ribbon to a print surface to print the temperature indicator according to the received layout. The melt temperature of the binding layer is higher than the threshold temperature.

In another aspect of the present disclosure, which may be used in combination with any other aspect or combination of aspects listed herein, the thermal transfer ribbon further includes a release coating coupling the binding layer to the backing substrate.

In another aspect of the present disclosure, which may be used in combination with any other aspect or combination of aspects listed herein, the release coating is a heat-responsive wax.

In another aspect of the present disclosure, which may be used in combination with any other aspect or combination of aspects listed herein, the temperature exposure indicator material is selected from the group consisting of: (a) an irreversible thermochromic indicator material configured to change color state in response to a temperature above the threshold temperature, (b) a reversible thermochromic indicator material configured to change color state in response to a temperature above the threshold temperature; (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the temperature exposure indicator material is (a), and the transferring of the binding layer from the backing substrate to the print surface, by the print head, is performed without the irreversible thermochromic indictor material changing color state.

In another aspect of the present disclosure, which may be used in combination with any other aspect or combination of aspects listed herein, the temperature exposure indicator material is (a), and the temperature exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In another aspect of the present disclosure, which may be used in combination with any other aspect or combination of aspects listed herein, the method further includes printing a barcode symbol on the print surface.

In another aspect of the present disclosure, which may be used in combination with any other aspect or combination of aspects listed herein, the print surface is a product surface.

In another aspect of the present disclosure, which may be used in combination with any other aspect or combination of aspects listed herein, the method further includes aligning the layout of the temperature indicator with a designated space on the print surface.

In another aspect of the present disclosure, which may be used in combination with any other aspect or combination of aspects listed herein, the method further includes receiving a label that includes a computer readable indicia encoding a data codeword applied thereon, the print surface being the label. Additionally, the method includes locating the computer readable indicia, and determining a print position for the temperature exposure indicator based on a position of the computer readable indicia or the data codeword encoded in the computer readable indicia.

In another aspect of the present disclosure, which may be used in combination with any other aspect or combination of aspects listed herein, the backing substrate is selected from the group consisting of polyester, polyethylene, paper, printable polyethylene terephthalate (“PET”), oriented polypropylene (“OPP”), and combinations thereof.

In another aspect of the present disclosure, which may be used in combination with any other aspect or combination of aspects listed herein, the binding layer includes an adhesive that is solvent based, aqueous emulsion based, or water soluble.

In another aspect of the present disclosure, which may be used in combination with any other aspect or combination of aspects listed herein, the adhesive includes at least one material selected from the group consisting of an aqueous emulsion adhesive, an acrylic polymer or co-polymer, an amine salt of an acrylic co-polymer, a carnauba wax, a candelilla wax, a hydrocarbon wax, Neocryl A-1052, Neocryl BT-24, Neocryl B-818, Epotuf 91-263, Ottopol 25-50E, Ottopol 25-30, Joncryl 682, and Joncryl 538A.

In another aspect of the present disclosure, which may be used in combination with any other aspect or combination of aspects listed herein, the adhesive has a melt temperature that is in the range selected from the group consisting of about 50 to 110° C., about 60 to 110° C., about 70 to 110° C., about 80 to 110° C., about 90 to 110° C., about 100 to 110° C., about 50 to 100° C., about 60 to 100° C., about 70 to 100° C., about 80 to 100° C., about 90 to 100° C., about 70 to 90° C., and about 80 to 90° C.

In another aspect of the present disclosure, which may be used in combination with any other aspect or combination of aspects listed herein, the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the threshold temperature is one of 35° C., 40° C., 45° C., 50° C. and 60° C.

In another aspect of the present disclosure, which may be used in combination with any other aspect or combination of aspects listed herein, the threshold temperature is 40° C.

In another aspect of the present disclosure, which may be used in combination with any other aspect or combination of aspects listed herein, the print head has a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the print head is configured to heat at least a portion of the thermal transfer ribbon to a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the temperature exposure indicator material further comprises a leuco dye, a micro-encapsulated leuco-dye, an SCC Polymer, a water-based SCC polymer emulsion, a diacetylene, an alkane, a wax, an ester or combinations thereof.

In another aspect of the present disclosure, which may be used in combination with any other aspect or combination of aspects listed herein, the temperature exposure indicator material has a particle size in the range selected from the group consisting of about 0.1 to 15 microns, about 0.1 to 10 microns, about 0.4 to 10 microns, about 0.4 to 10 microns, about 5 to 10 microns, about 6 to 10 microns, about 7 to 10 microns, about 8 to 10 microns, about 9 to 10 microns, about 1 to 9 microns, about 1 to 8 microns, about 1 to 7 microns, about 1 to 6 microns, about 1 to 5 microns, about 1 to 4 microns, about 1 to 3 microns, about 1 to 2 microns, about 3 to 7 microns, about 3 to 6 microns, about 3 to 5 microns, about 4 to 7 microns, and about 4 to 6 microns.

In another aspect of the present disclosure, which may be used in combination with any other aspect or combination of aspects listed herein, the temperature exposure indicator material has a particle size between 400 nm and 600 nm.

In another aspect of the present disclosure, which may be used in combination with any other aspect or combination of aspects listed herein, the temperature exposure indicator material has a concentration, in the binding layer, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

In another aspect of the present disclosure, which may be used in combination with any other aspect or combination of aspects listed herein, the substrate has a thickness from about 4 microns to about 6 microns.

In another aspect of the present disclosure, which may be used in combination with any other aspect or combination of aspects listed herein, the binding layer has a thickness from about 2 microns to about 50 microns.

In another aspect of the present disclosure, which may be used in combination with any other aspect or combination of aspects listed herein, the temperature exposure indicator material is (c), and the second lower temperature threshold is in the range selected from the group consisting of <4° C., <0° C., <−5° C., <−10° C. and <−15° C.

In another aspect of the present disclosure, which may be used in combination with any other aspect or combination of aspects listed herein, the binding layer includes at least one additive configured to increase the heat capacity of the binding layer.

In another aspect of the present disclosure, which may be used in combination with any other aspect or combination of aspects listed herein, the binding layer include a plasticizer from the group consisting of: glycerol, propylene glycol, polyethylene glycol (“PEG”), phthalate ester, dibutyl sebacate, citrate ester, and triacetin.

Aspects of the subject matter described herein may be useful alone or in combination with one or more other aspects described herein. In an aspect of the present disclosure, a method of making temperature exposure indicator printing stock includes receiving a thermal paper stock, and applying a thermochromic temperature indicator material to the thermal paper stock. The thermochromic temperature indicator material is configured to change color state in response to reaching a temperature that is lower than the printing temperature of the thermal paper stock.

In another aspect of the present disclosure, which may be used in combination with any other aspect or combination of aspects listed herein, the method further includes applying a varnish or coating over the thermochromic temperature indicator material.

In another aspect of the present disclosure, which may be used in combination with any other aspect or combination of aspects listed herein, the thermal paper stock is a direct thermal print paper containing a thermochromic pigment configured to change color when reaching the printing temperature.

In another aspect of the present disclosure, which may be used in combination with any other aspect or combination of aspects listed herein, the printing temperature is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

In another aspect of the present disclosure, which may be used in combination with any other aspect or combination of aspects listed herein, the temperature for the temperature indicator material is in the range selected from the group consisting of about 20 to 50° C., about 30 to 50° C., about 40 to 50° C., 20 to 40° C., about 20 to 30° C., about 25 to 35° C., about 30 to 35° C., about 32.5 to 35° C., and about 34 to 36° C.

In another aspect of the present disclosure, which may be used in combination with any other aspect or combination of aspects listed herein, the temperature exposure indicator material is selected from the group consisting of: (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the group further consists of: (f) an indicator material configured to change color state responsive to exposure to radiation, (g) an indicator material configured to change color state responsive to exposure to light of a predetermined wavelength, and (h) an indicator material configured to change color state responsive to exposure to humidity.

Aspects of the subject matter described herein may be useful alone or in combination with one or more other aspects described herein. In an aspect of the present disclosure, a method of making a temperature exposure indicator includes receiving a thermal paper stock having a thermochromic temperature indicator applied thereto. The thermochromic temperature indicator configured to change color state above a threshold temperature. The method also includes printing on the thermal paper stock using a direct thermal print process through the thermochromic temperature indicator using a thermal print head causing portions of the thermal paper stock to reach a print temperature higher than the threshold temperature without triggering the change in color state of the thermochromic temperature indicator.

In another aspect of the present disclosure, which may be used in combination with any other aspect or combination of aspects listed herein, the thermal paper stock includes a dye encapsulated in a matrix that is configured to change state when reaching the printing temperature.

In another aspect of the present disclosure, which may be used in combination with any other aspect or combination of aspects listed herein, the temperature exposure indicator material is selected from the group consisting of: (a) an irreversible thermochromic indicator material configured to change color state in response to a temperature above the threshold temperature, (b) a reversible thermochromic indicator material configured to change color state in response to a temperature above the threshold temperature, (c) a reversible thermochromic indicator material configured to change color state in response to a temperature below the threshold temperature, (d) a semi-reversible thermochromic indicator material configured to change color state in response to a temperature above the threshold temperature, and to maintain the changed color state until the temperature falls below a second lower temperature threshold, and (e) an irreversible thermochromic indicator material configured to change color state responsive to cumulative heat exposure over time.

In another aspect of the present disclosure, which may be used in combination with any other aspect or combination of aspects listed herein, the group further consists of: (f) an indicator material configured to change color state responsive to exposure to radiation, (g) an indicator material configured to change color state responsive to exposure to light of a predetermined wavelength, and (h) an indicator material configured to change color state responsive to exposure to humidity.

In another aspect of the present disclosure, which may be used in combination with any other aspect or combination of aspects listed herein, a non-transitory machine-readable medium stores code, which when executed by at least one processor is configured to perform any of the preceding aspects listed herein.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 is a block diagram of an example thermal transfer ribbon, according to an example embodiment of the present disclosure.

FIGS. 2A, 2B, and 2C are block diagrams of example thermal transfer ribbons, according to an example embodiment of the present disclosure.

FIG. 3A is a block diagram of an example direct thermal printer stock, according to an example embodiment of the present disclosure.

FIG. 3B is a block diagram of an example label, according to an example embodiment of the present disclosure.

FIG. 4 is a block diagram of an example printing process, according to an example embodiment of the present disclosure.

FIG. 5 is a block diagram of an example label, according to an example embodiment of the present disclosure.

FIGS. 6A, 6B and 6C are block diagrams of an example direct thermal label, according to an example embodiment of the present disclosure.

FIG. 7A is a flowchart illustrating an example process for manufacturing a thermal transfer ribbon, according to an example embodiment of the present disclosure.

FIG. 7B is a flowchart illustrating an example process for applying a temperature indicator to a print surface with a thermal transfer ribbon, according to an example embodiment of the present disclosure.

FIG. 7C is a flowchart illustrating an example process for making a temperature exposure indicator printing stock, according to an example embodiment of the present disclosure.

FIG. 7D is a flowchart illustrating an example process for making a temperature exposure indicator, according to an example embodiment of the present disclosure.

FIG. 7E is a flowchart illustrating an example process for making an environmental exposure thermal paper, according to an example embodiment of the present disclosure.

FIG. 7F is a flowchart illustrating an example process for making an environmental exposure dataform, according to an example embodiment of the present disclosure.

FIG. 7G is a flowchart illustrating an example process for making an environmental exposure thermal transfer ribbon, according to an example embodiment of the present disclosure.

FIGS. 8A, 8B, 8C, 8D and 8E are tables of experimental results of example embodiments of the present disclosure.

### DETAILED DESCRIPTION OF EXAMPLE EMBODIMENTS

Thermal transfer ribbons and direct thermal printer stock with environmental exposure indicator material, such as a temperature exposure indicator material are disclosed herein. Additionally, techniques for making the thermal transfer ribbons and direct thermal printer stock, as well as techniques for printing environmental exposure indicators, such as temperature exposure indicators, with the thermal transfer ribbons or the direct thermal printer stock are disclosed. Prior applications involving thermal printing have not addressed applying a temperature exposure indicator material, such as ascending temperature threshold exposure indicator material (also sometimes referred to as a peak temperature exposure indicator) that changes color state in response to temperature exposure above or below a threshold temperature through the thermal printing process for temperature monitoring. Instead, existing thermal printing processes often print static information that is not sensitive to environmental factors such as temperature, time, time-temperature product, freezing, nuclear radiation, toxic chemicals, or the like.

The printing methods and materials disclosed herein describe thermal transfer ribbons and direct thermal media. For some applications, information that varies from label to label, or document to document, or from batch of labels to batch of labels, may be printed with a thermal printer, while information that is the same on each document may be preprinted using flexographic printing or other methods before the label is loaded into the thermal printer. Some thermal printers may be configured to print via thermal transfer printing when a thermal transfer ribbon is loaded and configured to print via direct thermal printing when direct thermal media is loaded. Some thermal printers may comprise a sensor to sense when a thermal transfer ribbon is loaded. Some thermal transfer printers may comprise at least a first thermal print head configured to transfer a first rendered bitmap to a document and a second thermal print head configured to transfer a second rendered bitmap to the document. In other instances, the thermal printers may be configured to print via dye-sublimation printing when a ribbon with dye-sublimation panels is loaded and to print via thermal-transfer printing when loaded with a ribbon with thermal-transfer panels or with a thermal-transfer ribbon.

Materials, such as ink, dye, paint, toner, or wax may be used to color a surface to produce an image, text, graphic or barcode symbol. As used herein, a barcode symbol is a machine-readable pattern encoding data. The barcode symbol is one type of dataform. Other types or examples of dataforms include text, numbers, graphics, etc. Text is a dataform representing written language, numbers are dataforms representing arithmetical values, and graphics are dataforms representing images.

A barcode symbol may be made up of one or more barcode elements, which may be referred to as a barcode module. An element or module is a set of contrasting patterns that are arranged on a substrate to facilitate decoding data by a barcode reader or scanner. A barcode element or module may describe both a “black” box and a “white” box, or a “light absorbing” box and a “light reflective” box. In other examples, a barcode element or module may also describe a “light emitting” element, if luminescent materials are used. Some barcode symbols include quiet space(s), a region surrounding a set of elements or modules, which is free of contrasting marks, to enable the barcode reader to detect the barcode symbol in a captured image. Some barcode symbols include elements or modules, called finder patterns that provide a consistent pattern to enable the barcode reader to detect the barcode symbol in a captured image.

The procedure in which data is encoded in the barcode symbol, the arrangement of the barcode elements or modules within the barcode symbol, and any requirements for elements or modules and quiet space are defined by a set of rules, known as a barcode symbology. Data may be encoded into the contrasting patterns by software, such as a computer application or printer firmware.

Barcode symbols, which may be generally referred to herein as barcodes, may be displayed on a screen or marked on a substrate. Barcode elements or modules may be marked on a substrate in a variety of ways. Black bars (rectangles, squares, circles, or triangles, or other shapes are generally called bars, or elements, in a barcode) may be printed on a white or mirrored substrate to create the contrasting pattern of an element or module. Similarly, white patterns may be printed on a black or transparent substrate to create the contrasting pattern of an element or module. In either case, a barcode reader would capture an image of the barcode by receiving light reflected from the white portions of the element or module at a greater intensity than light reflected from the black portions of the element or module. The contrasting intensity pattern of the captured image is then processed by the barcode reader to decode the data carried by the barcode. In some embodiments, a reflective or mirrored surface may provide the contrasting pattern. Barcode elements or modules may also be marked on a substrate by etching or denting a smooth surface; in this case light is received at different intensities from a smooth surface than the textured surface.

The barcode symbols may be used in many industries to facilitate fast and accurate entry of data. Using a barcode scanner, a busy nurse in a healthcare venue may scan a first barcode printed on a patient wristband to link to an electronic health record detailing a prescribed medication, then scan a second barcode printed on a label affixed to a vial of medicine to link to drug information associated with a National Drug Code (“NDC”). Software may compare the prescribed medication with the drug information to confirm the nurse is administering the right medicine of the correct dose at the right time to the right patient. While the nurse could make the same comparison using a patient ID on a wristband, a handwritten prescription, a pharmacist's notes on a pill container, and her watch, the barcode-based system provides better accuracy and requires less detailed attention from the nurse, freeing her to provide personalized care to the patient

In another application, a dockworker in the receiving area of a large resort may receive hundreds of shipments containing food, liquor, hotel supplies, merchandise, conference materials, or furnishings during a typical day. Using a barcode scanner, the dockworker may scan a barcode printed on packaging, shipping documents, a parcel label or a pallet label to link to an advanced shipping notice in a site-management database detailing the contents of each shipment and the area of the resort which needs the received item. While all received items must ultimately be moved, the information from the site-management database may alert the dockworker to special handling requirements. Live lobsters may be expedited to the kitchen, ice cream must remain frozen, fresh chicken should remain refrigerated but not frozen, expensive liquor in fragile bottles may be secured in locked storage before being distributed to bars, conference materials may be expedited to an organization's event, while shampoo or hand sanitizer can probably wait a few hours before being delivered to housekeeping. While an experienced dockworker could set priorities for each received item based on routing information on the parcel or pallet, the barcode-based system provides easy-to-understand directions based on current situations within the resort, leading to less handling, quicker turn-around for delivery trucks, faster delivery, reduced waste, and a lot less worry from chefs, bartenders, managers, and guests

Documents with barcodes may be printed on labels, tags, wristbands, packaging, and other substrates in many ways. Paper documents and wristbands may be printed on laser printers which charge a drum with a rendered image, attract toner to the charged image, and apply that toner to a document or wristband form, then fuse the toner to the substrate using a heated roller. Thermal printing may be particularly well-suited to printing barcodes because commercially available barcode label printers are configured to render a barcode and print it on a label, tag, wristband, plastic card, RFID smart label, or similar substrates at high-speed while maintaining crisp edge contrast between dark elements and bright elements of the barcode, to handle webs of labels or wristband with excellence dimensional tolerance, and to connect easily to various computer systems and networks.

To print labels or other documents, thermal printers may use a thermal print head comprising a row of addressable heating elements to heat a thermal media. The elements are small compared to the image to be printed; e.g., 8, 12, or 24 elements per mm, and other resolutions, are commercially available. This differs from thermal inkjet printers which use addressable heaters to heat an ink or wax that is dropped or ejected to a document or other printable media.

Some embodiments described in this disclosure provide a unique way of printing coded sensor information (either alone or with pre-printed static data) on a printable media or substrate. The preprinted data and coded sensor information may be combined in a single step, or the coded sensor information may be added dynamically to the preprinted data in a secondary step depending on the actual planned sensor usage.

### Temperature Indicator Materials

As used herein, the terms “threshold” and “threshold temperature” have their normal meaning in the art and include a temperature, usually a temperature above 0° C. (though temperatures below 0° C. are also contemplated), that can cause damage or harm to a product, such as a food or a vaccine that generally requires refrigeration to avoid spoilage or maintain efficacy for extended periods. The term “threshold temperature,” then, can be any predetermined temperature that is above a desired storage temperature of a perishable product.

The term “melt onset temperature” is used herein to refer to the lowest temperature at which a threshold indicator dispersion, or deep eutectic solvent, exhibits a detectable melt-induced appearance change that can be unmistakably determined by observation, visual or otherwise. The observable change can be a change from opaque to clear, the disappearance of ice crystals, clearing, a change in color, a change in electrical conductivity, etc.

The environmental or temperature indicators described herein may be generally referred to as a dynamic indicator. In an example, the environmental exposure indicator materials may include one or more dynamic materials. The dynamic materials may be adapted to change state, e.g., optical property such as color responsive to an external event or condition. For example, the dynamic indicator may be an environmental indicator or sensor, a medical indicator or sensor, etc. Examples of environmental sensors include temperature monitors, measuring either cumulative heat exposure or passing beyond a set high or low temperature threshold value(s); time, time-temperature product, nuclear radiation exposure monitors; gas or humidity exposure monitors each passing above a cumulative exposure threshold or an instantaneous threshold value. Examples of medical sensors include recording patient thermometers; threshold assays measuring levels to biological toxins such as aflatoxin or botulism toxin; and includes colorimetric immunoassays for sensing of the presence of biological agents such as prions or biological organisms such as infectious bacteria.

### Thermal Transfer Ribbons

Various thermal printing technologies may be used to print dataforms, such as barcode symbols. A thermal transfer printer uses a thermal transfer ribbon as the thermal media. The thermal transfer ribbon may be coated with a binder, e.g., a meltable wax or resin and an ink. The thermal transfer ribbon is aligned with the web of labels and moved past the thermal print head, which presses the ribbon to the web of printable media. The thermal print head receives data of a rendered bitmap and heats specific heating elements within the row of addressable heaters according to the data. Heat from the heated elements melts the ribbon's binder adjacent to the heating element, causing the ink to be transferred to the printable media. In the present disclosure, thermal transfer ribbons may be provided that include particular types of special inks, e.g., inks which change color or appearance in response to temperature.

Print head heating elements which are not heated do not cause the wax or resin of the adjacent ribbon to be melted so no ink is transferred to the media in those areas. This allows the thermal print head to print a single row of dots to the media: it could be a solid line, a blank line, or any row of a rendered image that may include a barcode, text, or graphics. As the media and ribbon move past the thermal print head the printed line cools, causing the printed image to be permanently affixed to the media. The process is repeated for subsequent lines until the rendered image is printed on the media. The resulting document may include the environmental exposure indicator material, the wax or resin binder, or sometimes other materials that have been coated onto the thermal transfer ribbon.

Because the print head heating elements are small and the media web is moved at a high speed, and most of the heat from the print head is consumed in melting the wax or resin binder thereby preventing most of the heat from being conducted to the other portions of the ribbon (e.g., by the environmental exposure indicator material) as well as the printable media. For example, typically a small amount of heat is conducted into the other portions of the ribbon (e.g., by the environmental exposure indicator material), which advantageously prevents the printing process from affecting the color state of the environmental exposure indicator material. Additionally, this makes thermal transfer printing well suited to printing documents on synthetic printable media or materials that are sensitive to heat and for labels with adhesives that are sensitive to heat. Printable media may be chosen to provide contrasting color to the ribbon, e.g. white or color labels are typically used with black ribbons and black or transparent labels are typically used with white ribbons.

Various types of thermal transfer ribbons may be manufactured. A thermal transfer ribbon may comprise a backing substrate such as a plastic film. Onto a first side of the backing substrate is first coated back coating material which reduces friction and/or improves heat transfer between the thermal print head and the thermal transfer ribbon. Onto the opposing side of the backing substrate is second coated a binder, perhaps a wax or resin material, then third coated an ink or other colored material, then fourth coated a protective layer to prevent the ink from smudging or flaking off of the ribbon before it has been heated by the thermal print head. For some ribbons, the third coating layer may comprise patterns or inks of different colors. When printing, the thermal print head is positioned on the first side of the backing substrate, with the second side of the backing substrate facing the binding layer, the ink layer, and the printable media. For some ribbons, various coatings may be combined or omitted.

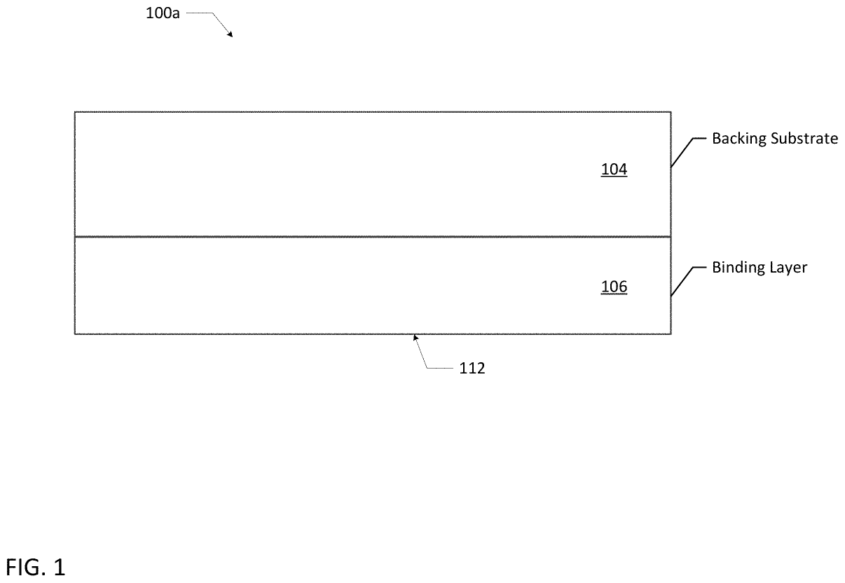

FIG. 1 illustrates an example embodiment of a thermal transfer ribbon 100. The thermal transfer ribbon 100 is used to transfer an environmental exposure indicator material, such as an ink, from a backing substrate 104 to a print media (not illustrated). In an example, the backing substrate 104 may be a plastic film. A thermal print head utilizes heat to activate adhesion of the binding layer 106 to the print media such that the binding layer 106 breaks away from the backing substrate 104 (e.g., carrier or ribbon) and remains affixed to the print media. In an example, the thermal transfer ribbons are adapted such that upon application of heat from a thermal print head, the binding layer 106 fractures at the edge of a pattern, and the thermal ribbon advantageously minimizes or eliminates tearing beyond the pattern. As illustrated in FIG. 1, a thermal transfer ribbon 100 includes a backing substrate 104 (e.g., polyester) and a binding layer 106 that includes the environmental exposure indicator material, such as a temperature exposure indicator material.

The environmental exposure indicator material is configured to change color state in response to environmental exposure above or below a threshold exposure level. One example of an environmental exposure indicator material is an ascending temperature threshold exposure indicator material (also sometimes referred to as a peak temperature exposure indicator) that is configured to change color state in response to temperature exposure above or below a threshold temperature. Throughout this disclosure, when “temperature exposure indicator” is used (without some other modifier, such as “cumulative” or “descending”) it refers to an ascending temperature threshold exposure indicator.

Cumulative exposure indicators are configured to change state (e.g., color state) in response to a cumulative exposure to an environmental condition. For example a cumulative temperature indicator may measure either cumulative heat exposure or passing beyond a set high or low temperature threshold value(s), time, or time-temperature product. Other example cumulative exposure indicators may include nuclear radiation exposure monitors, gas or humidity exposure monitors each passing above a cumulative exposure threshold.

Ascending and descending indicators and indicator compositions may utilize deep eutectics, which is a deep eutectic liquid or solvent (“DES”) exhibiting a melting temperature that is distinct from its freezing temperature, such that upon exposure to a desired low temperature, the DES freezes in an observable manner, which may be a visual change in appearance (for example by scattering light) or some other change that is observable, such as electrical conductivity. Alternatively, upon exposure to a desired threshold temperature, some DESs may melt in an observable manner, which may be a visual change in appearance (for example by becoming transparent or translucent) or some other change that is observable, such as electrical conductivity Because of the difference between melting temperature and freezing temperature, the DESs and indicators utilizing the DESs may be able to maintain the observable change even when subsequently exposed or returned to a temperature within the desired range for storage.

A number of different DESs may be suitable for use in freeze or threshold indicators. For example, DESs may be achieved with a suitable organic salt such as choline chloride and a hydrogen bonding donor such as urea, substituted ureas, glycerol, glycols—such as ethylene glycol—etc. or a metal salt hydrate. In some embodiments, the components are mixed together, heated, and stirred to give a liquid with a much lower freezing point than the individual components, hence the term deep eutectic. The actual freezing point may depend on the ratios of the two (or possibly more) components. There is some particular ratio where the freezing point will be a minimum. Example deep eutectic indicator materials are described in U.S. Publication No. 2019/0285482.

In the present disclosure, an ascending temperature indicator may include threshold temperature indicators that can be used to determine if a perishable product has been exposed to a temperature above an acceptable temperature or range of temperatures. Some embodiments of a threshold indicator according to the present disclosure can exhibit an unmistakable heat-induced appearance change in a relatively short period of time, for example within 1 hour of exposure to the melt onset temperature, or a higher temperature. The indicators may yield an unmistakable heat-induced appearance change, consistently and reliably, from one sample to the next, after exposure for shorter time periods, for example, 15 minutes, or 5 minutes, or another period under about 30 minutes

In the present disclosure, a descending temperature indicator may include freeze indicators that can be used to determine if a perishable product has been exposed to a temperature below an acceptable temperature or range of temperatures. Some embodiments of a freeze indicator according to the present disclosure can exhibit an unmistakable freeze-induced appearance change in a relatively short period of time, for example within 1 hour of exposure to the freeze onset temperature, or a lower temperature. The indicators may yield an unmistakable freeze-induced appearance change, consistently and reliably, from one sample to the next, after exposure for shorter time periods, for example, 15 minutes, or 5 minutes, or another period under about 30 minutes.

In the present disclosure, a temperature indicator may include a thaw indicator, which may have temperature ranges from 0° C. to −80° C. Example thaw indicators are materials that are tuned to change state at or slightly below the point where a product or material, which is normally distributed frozen, will thaw. Some examples are described in U.S. Pat. Nos. 7,624,698, 7,891,310 and 8,128,872. The thaw indicators may include some of the semi-reversible thermochromic indicator materials described herein, which are configured to change color state in response to a temperature above a threshold temperature, and to maintain the changed color state until the temperature falls below a second lower temperature threshold. For example, the semi-reversible thermochromic ink may have a blue color at room temperature, the color may change from blue to colorless at temperatures above 50° C., and may change back to a blue color when exposed to temperatures below 0° C. The thaw indicators may use liquid crystal technology, e.g., one example of a liquid crystal ink is offered by LCR Hallcrest having a temperature range from 0° C. to 90° C. Another example commercially available thaw indicator is StaFreez® provided by Biosynergy, which is an irreversible freeze-thaw indicator that monitors the condition of frozen (biomedical) materials during shipping and storage. The StaFreez® indicators are activated at the time of their use by heating the indicator to 40-50° C. and immediately applying the indicator to frozen material (−20° C. or lower). A bright blue “F” will appear, indicating that the material is frozen. As the frozen material is warmed above −20° C., the color of the “F” will change gradually from bright blue to blue-gray, gray, and will become black as the frozen material reaches 0° C. If the thawed material is re-frozen, the “F” will remain black, indicating that the material has thawed during its history. Some of the semi-irreversible indicators (e.g., memory indicators) discussed herein may be described as a thaw indicator.

The binding layer 106 is positioned to couple the temperature exposure indicator material to the backing substrate 104. The binding layer 106 is also configured to release the environmental exposure indicator material (e.g., temperature exposure indicator material) to a printable media when heated by a print head. In an example, the binding layer 106 may have a melt temperature higher than the threshold temperature of the temperature exposure indicator material, but the binding layer 106 or a portion of the binding layer 106 may be transferrable to the printable media without the temperature exposure indicator material changing color state. In an example, the temperature exposure indicator may change color state after a temperature exposure of at least ten seconds, which is longer than a typical print operation, thereby preventing a change in color state during the printing process. For example, the temperature exposure indicator material may be configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

In some examples, the temperature exposure indicator's activation temperature may be determined by the melting point of the indicator. For example, when the temperature exposure indicator is exposed to an ambient temperature above its activation temperature, the indicator material may liquefy. Once liquefied, the indicator material may diffuse causing a change in the appearance of the indicator. In other examples, the temperature indicator (such as a peak exposure indicator) may include a first reactant, a second reactant and a meltable solid. The first reactant may be chemically co-reactable with the second reactant to provide a color change and the meltable solid may physically separate the first reactant from the second reactant. The color-changing chemical reaction may be induced in response to an ambient heat exposure peak, which may be a peak that exceeds the melting point of the meltable solid. For example, melting of the meltable solid caused by the ambient heat exposure peak may bring the first reactant into contact with the second reactant. Such a dual-function heat indicator may indicate cumulative ambient heat exposure and/or peak ambient heat exposure by changing color.

As used herein, the term “melting temperature”, or “melting point” refer to the temperature at which a material exhibits peak unit heat absorption per degree Celsius, as determined by differential scanning calorimetry. Above its melting temperature, the transport material can exhibit liquid properties and can move, for example, flow or diffuse.

In another example, the ribbon 100 may be formulated and constructed such that most of the heat from the print head may be consumed in melting the wax or resin binder thereby preventing heat from being conducted by the other portions of the ribbon (e.g., by the environmental exposure indicator material). This may happen for any of at least several reasons: (1) the mass of the binder serves to insulate the ink, thereby preventing transfer of heat to the ink, (2) the indicator may be insulated by other materials, e.g., a matrix in which the temperature state changing material is embedded, (3) the mass of the binder is much smaller than the mass of the indicator, so the amount of the heat required to melt or otherwise transform the indicator state is much higher than the amount of heat needed to melt or otherwise release the binder, (4) where the indicator changes state by melting, the latent heat of fusion of the binder may be much lower than the latent heat of fusion of the indicator, so the amount of exposure to the critical temperature needed to cause the binder to release is much less than the amount of heat needed to change the indicator state.

The binding layer 106 or a portion of the binding layer 106 transfers to the printable media because when heated, the binding layer 106 has a stronger adhesion (e.g., a higher adhesion) to the print media than the binding layer's adhesion to the backing substrate. For example, the binder may be physically bonded to the ribbon by being embedded in the physical matrix of the ribbon and these bonds may release when the binder melts, the binder may have reduced adhesion to the ribbon when it changes state, and the binder or additional additives to the ribbon may tend to increase the adhesion of the ink to the printable substrate.

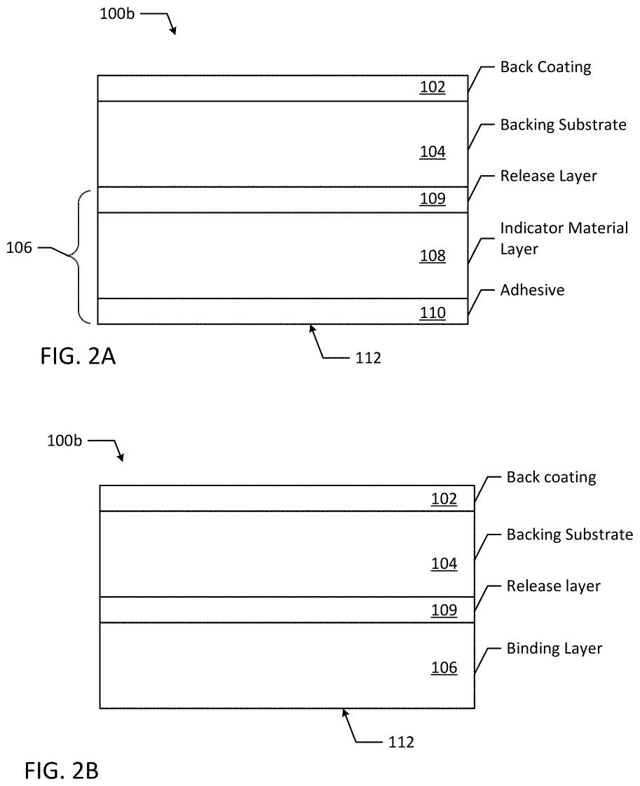

FIGS. 2A, 2B and 2C illustrate different embodiments of a thermal transfer ribbons 100b, 100c and 100d. As illustrated in FIG. 2A, a thermal transfer ribbon 100b includes a back coating 102, a backing substrate 104 (e.g., polyester), and a binding layer 106. The binding layer 106 may include one or more sub-layers such as a release coating or layer 109, an indicator material layer 108, and an adhesive layer 110. FIG. 2B illustrates another example of a thermal transfer ribbon 100c that includes a back coating 102, a backing substrate 104 (e.g., polyester), a release layer 109, and a binding layer 106. FIG. 2C illustrates a cold foil type transfer ribbon 100d that includes a backing substrate 104, such as a release polyester, and an indicator material layer 108. The indicator material layer 108 may be a non-adhesive layer.

Example backing substrates 104 include polyester, polyethylene, paper, printable polyethylene terephthalate (“PET”), oriented polypropylene (“OPP”), and combinations thereof. The carrier or backing substrate 104 may have a non-stick surface 122 on the print head side and a release surface 119 between the backing substrate 104 and the indicator material layer 108. The backing substrate 104 (e.g., the release polyester) may have a thickness of approximately 5 to 12 micrometers, preferably between 5 to 6 micrometers and more preferably 4.8 micrometers. The indicator material layer 108 may have a thickness of approximately 2 to 50 micrometers, preferably 2 to 4 micrometers.

The thermal transfer ribbons 100a, 100b, 100c and 100d (hereinafter referred to generally as thermal transfer ribbon 100) may include additives that advantageously improve dispersion, coating, and/or printing. Depending on the application, the thermal transfer ribbon 100 may be sized and shaped such that the consumption of environmental exposure indicator material, such as temperature exposure indicator material, is minimized during printing. For example, the thermal transfer ribbon 100 may be selectively coated with the environmental exposure indicator material or the width of the thermal ribbon 100 may be changed to reduce the amount of environmental exposure indicator material left behind on a used thermal transfer ribbon 100.

The back coating 102 may be a heat-resistant layer that includes a heat-resistant binder(s) and a slip agent(s). The back coating 102 is adapted to provide sufficient heat resistance to protect the backing substrate 104, which may also be referred to as a film or carrier, and prevent sticking between the printer head and ribbon 100. The back coating 102 may also be adapted to improve heat transfer between the thermal print head and the thermal transfer ribbon 100. Additionally, the back coating 102 is adapted to provide sufficient slip characteristics to the thermal transfer ribbon 100. In an example, the back coating 102 may have a thickness of approximately 0.5 micrometers.

The back coating 102 may be prepared as a solution or dispersion in solvent or water and applied to backing substrate 104 as a liquid using standard printing or coating techniques followed by drying and/or curing. In an example, back coating 102 may be prepared by adding slipping agent(s), surfactant(s), inorganic particle(s), organic particle(s) or the like to a binder resin. Example resins include cellulose resins such as ethyl cellulose, hydroxy ethyl cellulose, hydroxy propyl cellulose, methyl cellulose, cellulose acetate, cellulose acetate butyrate, nitrocellulose or the like; vinyl-type resins such as polyvinyl alcohol, polyvinyl acetate, polyvinyl butyral, polyvinyl acetal, polyvinyl pyrrolidone, acrylic resin, polyacrylamide, acrylonitrile-styrene copolymer or the like; polyester resin; polyurethane resin; silicone-modified urethane resin or fluorine-modified urethane resin or the like.

In other examples, the back coating 102 may be unnecessary if the backing substrate 104 provides sufficient heat resistance and/or slip properties to the thermal transfer ribbon 100. However, when using a backing substrate 104 with low heat resistance, it may be preferable to provide a heat-resistant layer or back coating 102 on a rear surface of the thermal transfer ribbon 100. Since the rear surface is contacted by the thermal print head, the back coating 102 advantageously improves a slipping property of the thermal print head and prevents the thermal print head from sticking to the thermal ribbon 100.

In an example, the backing substrate 104 is a polymer film, such as polyester. The polyester may be heat stabilized. In digital thermal transfer printing applications, the backing substrate 104 may be between 4.5 and 5.7 micrometers thick. Other backing substrate thicknesses may be used, for example, polyester that is 12, 17 or 24 micrometers thick, particularly if the printing is by step-and-repeat or rotary hot-stamping.

The thermal transfer ribbon 100 is adapted with release characteristics to ensure proper transfer of the environmental exposure material or the respective layer containing the environmental exposure material from the image side surface 112 of the film or ribbon 100 (e.g., side of ribbon 100 positioned towards the printable media). For example, the transfer ribbon 100 may include a release coating, release layer 109 or release surface 119 (see FIG. 2C) such that the bond between the backing substrate 104 and the binding layer 106 is weak enough to separate when subjected to heating from a thermal print head. In an example, the release coating or release layer 109 may be a heat-responsive wax that couples the binding layer 106 or indicator material layer 108 to the backing substrate 104. Specifically, the release layer 109 is to hold the binding layer 106 or other corresponding layer encapsulating the environmental exposure material to the backing substrate 104 so that it is not removed from any actions or activities on the ribbon prior to image generation. For example, the release layer 109 may be the first layer coated on the image surface side 112 of the ribbon 100 and may include a binder, perhaps a wax or resin material. Then, an indicator material layer 108 may be coated over the release layer 109. Additionally, a protective layer (not illustrated) may be coated over the indicator material layer 108 to prevent the indicator material or the indicator material layer 108 from smudging or flaking off of the ribbon before it has been heated by the thermal print head.

In an example, the backing substrate 104 may be treated with corona, flame, or plasma to provide a bond between the backing substrate 104 and the binding layer 106 or other corresponding layer encapsulating the environmental exposure material (e.g., indicator material layer 108) that is releasable in the printing process, yet holds the environmental exposure indicator material to the backing substrate through all stages of a printing process up until transfer to the printable media. The composition or chemistry of the environmental exposure indicator material in the binding layer 106, or other corresponding layer encapsulating the environmental exposure material (e.g., indicator material layer 108), may be matched to the backing substrate 104 such that an additional release layer 109 is unnecessary (e.g., for ribbons 100 used in hot-stamping).

The indicator material layer 108 or the binding layer 106 may include diacetylene monomer powder dispersed in nitrocellulose resin. Additionally, the indicator material layer 108 or the binding layer 106 may include a diacetylene monomer powder and/or acrylic resins. Additionally, the binding layer 106 may also include carnauba wax, candelilla wax, hydrocarbon wax, or a combination thereof. Both carnauba wax and candelilla wax have adhesive properties that are imparted to environmental exposure indicator material or a corresponding indicator material layer 108 (see FIG. 2A). Other waxes or additives may be used that have sufficient adhesive properties and appropriate melting points. In an example, the binding layer 106 may include a diacetylene monomer powder and a resin emulsion. The resin emulsion may be formed from Joncryl® emulsion 538A and Carnauba wax emulsion Actega product Aquacer 2650.

In another example, the ribbon 100 may include a release layer 109 such as a thin coating (e.g., from about 0.5 micrometers to 3 micrometers or from about 0.5 micrometers to 1.5 micrometers) of an adhesive material with a melting point such that it loses cohesive strength when subjected to the heat from an active nib or print head. Release layer 109 may include a layer of heat-responsive wax or wax-like material that forms a strong bond with the environmental exposure indicator material or its associated encapsulating layer. Heat from the thermal print head causes the heat-responsive wax to split allowing the environmental exposure indicator material or its associated encapsulating layer (e.g., binding layer 106) to separate from the backing substrate 104 of the ribbon 100. The heat-responsive wax or wax-like material is particularly beneficial for thin films and ribbons 100. For example, a heat-responsive wax may provide strong adhesion at both the interfaces between the backing substrate 104 and the layer encapsulating the environmental exposure material (e.g., binding layer 106) at room temperature (e.g., from about 20° C. to 25° C., preferably about of 23° C. or about 73.4° F.). Additionally, a heat-responsive wax may advantageously provide a room temperature bond and a high temperature release (e.g., a temperature above approximately 120° C. or about 250° F., for example approximately 300° F.) thereby allowing greater flexibility and broader compatibility in environmental exposure indicator material selections and/or formulations.

As mentioned above, in some examples, the release layer 109 may be avoided by using a film, carrier or backing substrate 104 with low adhesion properties. Processes using thicker backing substrates 104 (e.g., 12 to 24 microns) such as hot stamping in a step-and-repeat or rotary fashion, may perform better using a low adhesion backing substrate 104 rather than a heat-responsive wax as a release layer 109.

The binding layer 106 or other corresponding layer encapsulating or containing the environmental exposure indicator material may include an ink, dye, paint, toner, or wax that is applied to a thermal ribbon 100 in a first color state. The environmental exposure indicator material may comprise liquids, pastes, dyes, pigments, powders, polymers, etc. The binding layer 106 or other corresponding layer encapsulating or containing the environmental exposure indicator material may be applied to the backing substrate 104 or release layer 109 with a rod coater, a gravure coater, or with a precision coating device, such as a slot coater, a micro-gravure coater, a curtain coater or the like. Initially, the layer encapsulating or containing the environmental exposure indicator material (e.g., binding layer 106) may have little to no color at all and then the color or characteristics of the layer may change after being exposed to an environmental condition (e.g., time, temperature, etc.). The thickness of the layer encapsulating or containing the environmental exposure indicator material (e.g., binding layer 106) may depend on the printing application and type of environmental exposure indicator material used.

In an example, the binding layer 106 or indicator material layer 108 may be approximately 2 to 50 micrometers thick. For example, binding layers for diacetylene cumulative exposure indicator actives may be up to 25 micrometers thick. Additionally binding layers for SCC threshold temperature indicators may be up to 50 micrometers thick or more.

In an example, the environmental exposure indicator material, such as a temperature exposure indicator material, in the binding layer 106 may be a dispersion of pigments in nitrocellulose, which is capable of being digital thermal transfer printable. In another example, the environmental exposure indicator material in the binding layer 106 may be a dispersion of pigments in acrylic resin. The environmental exposure indicator material may be incorporated into a synthetic resin composition to form binding layer 106. Additionally, the environmental exposure indicator material may include an indicator such as a diacetylene monomer pigment, a matched pair of a leuco dye precursor and a leuco dye developer, free or encapsulated thermochromic liquid crystal composition, a wax or wax-like light scattering particle, or any other thermochromic material. For example, the environmental exposure indicator material may be an indicator such as a diacetylene monomer pigment, a matched pair of a leuco dye precursor and a leuco dye developer, free or encapsulated thermochromic liquid crystal composition, a wax or wax-like light scattering particle, or any other thermochromic material dispersed in acrylic resin. The binding layer 106 may include a high content of reactive or dynamic components (e.g., environmental exposure indicator material) to allow for thinner layers that encapsulate the environmental exposure indicator material, which may advantageously facilitate faster heat transfer and printing. Binding layers 106 with high heat transfer rates may also advantageously facilitate thermal transfer ribbons 100 with thicker binding layers 106 allowing more environmental exposure indicator material to be applied to the printable media.

The adhesive layer 110 may include a heat activated adhesive. For example, the adhesive layer 110 may transform from a first state (e.g., a hard non-tacky material at ambient temperatures) to a second state (e.g., a soft, conformable and tacky material) when heated. In an example, the adhesive may be incorporated into the binding layer 106 thereby forming a binding layer 106 with thermal adhesive properties. In an example, the thermal adhesive may be a thermoplastic. Additionally, the adhesive may be selected based on the printable media as some adhesives may not bond well to certain media. For example, an adhesive may be specifically formulated or selected to bond to specific printable media (e.g., polyethylene, paper, printable polyethylene terephthalate (“PET”), oriented polypropylene (“OPP”), etc.).

In the example illustrated in FIG. 2C, the binding layer 106 may function to encapsulate the environmental exposure indicator material and also function as a binder that aids in binding the environmental exposure indicator material to the backing substrate as well as the printable media once the ribbon is heated by a print head. In other examples, a separate adhesive layer 110 may be applied separately over an indicator material layer 108 (see FIG. 2A) to form a thin continuous layer on the image side surface 112 of the ribbon 100. Environmental exposure indicator material or pigment dispersed in an adhesive binder to form a binding layer 106 may advantageously allow thinner thermal ribbons 100 with the same printing quality as thicker thermal ribbons 100, and also eliminate the separate process of applying the adhesive 110 over the indicator material layer 108.

Example adhesives may be solvent based (e.g., Joncryl® 682), aqueous emulsion based (e.g., Joncryl® 538a), and/or water soluble, or a combination thereof. For example, the adhesive layer 110 may include Joncryl® 682 solution in solvent, Joncryl® 538A emulsion, or a Michelman adhesive emulsion, or the like. Similarly, the binding layer 106 may include the adhesives discussed above. In an example, the adhesive includes at least one material selected from the group consisting of an aqueous emulsion adhesive, an acrylic polymer or co-polymer, an amine salt of an acrylic co-polymer, a carnauba wax, a candelilla wax, a hydrocarbon wax, Neocryl A-1052, Neocryl BT-24, Neocryl B-818, Epotuf 91-263, Ottopol 25-50E, Ottopol 25-30, Joncryl 682, and Joncryl 538A.

The adhesives may have a melt temperature that is in the range selected from the group consisting of about 50 to 110° C., about 60 to 110° C., about 70 to 110° C., about 80 to 110° C., about 90 to 110° C., about 100 to 110° C., about 50 to 100° C., about 60 to 100° C., about 70 to 100° C., about 80 to 100° C., about 90 to 100° C., about 70 to 90° C., and about 80 to 90° C.

In an example, especially for certain environmental exposure indicator materials, such as temperature exposure indicator materials (e.g., time-temperature indicators), the adhesive should be configured such that it has negligible influence of the environmental exposure indicator material's color or appearance when printed. For example, the adhesive (e.g., adhesive layer 110) may be colorless or barely perceptible. Adhesives for use with visual indicating indicator materials preferably have little to no influence on the development of the indicator. Similarly, the release layer 109 is preferably adapted to have little to no interference with the development of the indicator. For example, both the release layer 109 and/or the adhesive (e.g., adhesive layer 110) are configured such that they neither advance nor retard the development of the environmental exposure indicator material.

### Direct Thermal Media

Another thermal printing technology for printing dataforms or images, such as barcode symbols, is direct thermal printing. A direct thermal printer does not use a ribbon, but instead the printable media itself is the thermal media. The direct thermal media is manufactured or coated with a thermochromic material that changes color when exposed to sufficient heat, such as a leuco dye, which switches from a first chemical form that is colorless to a second chemical form that is black or colored. The web of direct thermal media is pressed against and moved past the thermal print head. The thermal print head receives data of a rendered bitmap and heats specific heating elements within the row of addressable heaters according to the data.

Heat from the heated elements causes the thermochromic material on the printable media to transition from colorless to black or from colorless to colored. Print head heating elements which are not heated do not cause a color transition. In some direct thermal media, a first zone of the printable media includes thermochromic material that transitions from colorless to a first color while a second zone of the printable media includes thermochromic material that transitions from colorless to a second different color. Some direct thermal media comprises a multi-layer arrangement including a first layer of a first color and a second non-transparent layer of a second color. For the multi-layer arrangements, heat from the heated print head elements cause the second layer to transition to a transparent state revealing the color of the first layer.

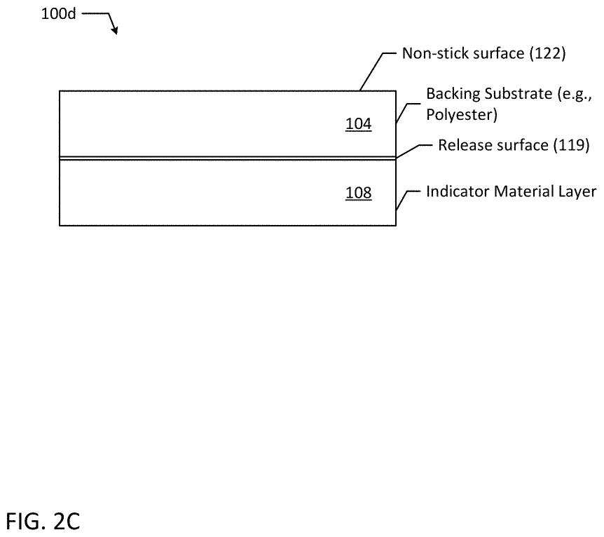

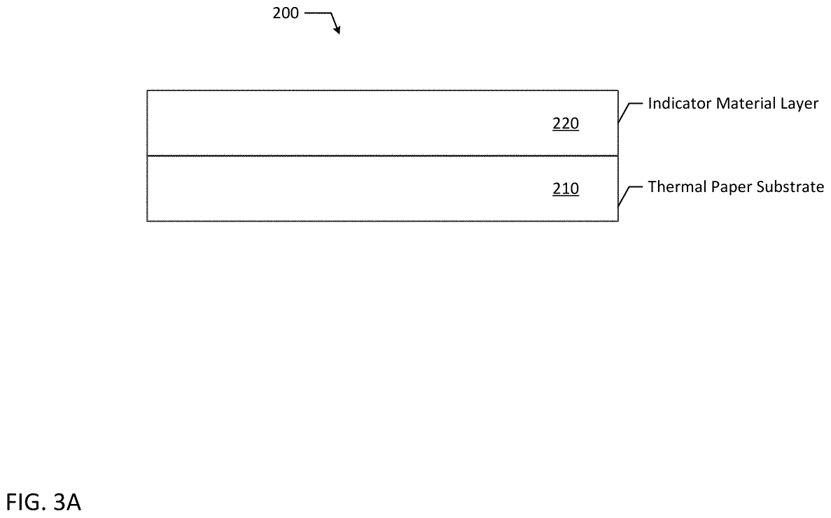

As illustrated in FIG. 3A, a direct thermal print media or direct thermal printer stock 200 may include a thermal paper substrate 210 and an indicator material layer 220. The indicator material layer may include an environmental exposure indicator material. In some examples, the indicator material layer 220 may be applied in a specific layout, geometry, pattern, etc. to form an environmental exposure indicator, such as a temperature exposure indicator.

In an example, the thermal paper substrate 210 is configured to be printed by a direct thermal print process with a heated thermal print head, the thermal paper substrate may have a print temperature and adapted to change color when heated by the heated thermal print head to or above the print temperature. Additionally, a temperature exposure indicator provided on the thermal paper substrate may include an environmental exposure indicator material that is configured to change color state in response to a temperature exposure above a predetermined threshold temperature, which is below the print temperature. In an example, the environmental exposure indicator material, such as a temperature exposure indicator material is a dye encapsulated in a matrix.

The direct thermal printer stock, and more specifically the direct thermal paper substrate 210 is configured for imaging a dataform on the direct thermal paper stock at a print temperature above the threshold temperature of the temperature exposure indicator material. The dataform may be imaged without the temperature exposure indicator material changing color state.

As illustrated in FIG. 3B, a label 250 may include a flexible substrate 260. The flexible substrate 260 may be a backing substrate 104, a ribbon 100 or a paper substrate, such as a direct thermal paper substrate. The flexible substrate 260 has a first side 262 and a second side 264. The first side 262 may be an adhesive 270. In another example, the adhesive 270 may be and adhesive layer applied to the flexible substrate 260. The second side 264 may be configured to be imaged or printed. In an example, the second side may be made up of one or more ink layer(s) 272. In an example, the second side has a printed, visible mark 280 and a printed, overlapping mark 290. The overlapping mark 290 may be configured to change opacity below a transition temperature to obscure the visible mark. In another example, the overlapping mark 290 may be configured to change opacity above a first transition temperature to obscure the visible mark. The change in opacity may be due to a change in color state according to the various other examples described herein.

In an example, the overlapping mark 290 may initially be transparent or may change from opaque to transparent. For example, the overlapping mark may change opacity from opaque to transparent at a second transition temperature, which may be the same as the first transition temperature or may be warmer than the first transition temperature. The adhesive 270 or the adhesive layer may be configured to attach the label 250 a vial or other product. In an example, the second transition temperature may be configured to change opacity when a liquid within the vial reaches a threshold temperature, such as 18° C. In one example, the visible mark may be light blue in color and the overlapping mark, when opaque, may be dark blue in color.

The flexible substrate 260 may comprise a thermochromic layer. The thermochromic layer may be the ink layer 272 or one of the layers within ink layer(s) 272. The thermochromic layer may be configured to be printed by a thermal printer at an imaging temperature. The thermochromic layer may be a top layer or coating configured to be printed by the thermal printer.

### Example Environmental Exposure Materials

As discussed above, the environmental exposure indicator material may include an ink, dye, paint, toner, or wax that is applied to a thermal transfer ribbon 100 or a direct thermal print media 200. The environmental exposure indicator material may comprise liquids, pastes, dyes, pigments, powders, polymers, etc. Examples of environmental exposure indicator materials, or the indicators printed therefrom, include temperature monitors, measuring either cumulative heat exposure or passing beyond a set high or low temperature threshold value(s); time, time-temperature product, nuclear radiation exposure monitors; gas or humidity exposure monitors each passing above a cumulative exposure threshold or an instantaneous threshold value; as well as light, such as ultraviolet (“UV”) exposure.

In an embodiment, the environmental exposure indicator material may be sensitive to an environmental factor such as temperature, time, time and temperature, freezing, radiation, toxic chemicals, or a combination of such factors, or the like. For example, the environmental exposure indicator material may be a temperature exposure indicator material, such as (a) an irreversible thermochromic indicator material configured to change color state in response to a temperature above the threshold temperature; (b) a reversible thermochromic indicator material configured to change color state in response to a temperature above the threshold temperature; (c) a reversible thermochromic indicator material configured to change color state in response to a temperature below the threshold temperature; (d) a semi-reversible thermochromic indicator material configured to change color state in response to a temperature above the threshold temperature, and to maintain the changed color state until the temperature falls below a second lower temperature threshold; or (e) an irreversible thermochromic indicator material configured to change color state responsive to cumulative heat exposure over time.

In other example, the environmental exposure indicator material may be (f) an indicator material configured to change color state responsive to exposure to radiation; (g) an indicator material configured to change color state responsive to exposure to light of a predetermined wavelength; or (h) an indicator material configured to change color state responsive to exposure to humidity. Example indicator materials, especially luminescent (or more particularly, phosphorescent or fluorescent) indicator materials are described in U.S. patent application Ser. No. 17/007,795. For example, the indicator material may be or may include a radiation indicator that exhibits a visual color change from yellow to red when exposed to radiation, such as P8200 from GEX Corporation. In an example, the radiation indicator may be applied to a backing substrate 104 with an Acrylic-based emulsion that functions as an adhesive with the indicator material provided in a polyvinyl butyral (“PVB”) resin ink coating. The humidity exposure indicators may be configured to change color in the presence of liquid moisture and high humidity. For example, Kimberly-Clark produces color changing inks that change from yellow to blue when exposed to liquid or water vapor. The color change is instantaneous with exposure to liquid, such as water, but the color change may takes longer, as a function of exposure time and humidity, when exposed to water vapor.

For threshold ascending temperature exposure indicators, example threshold temperatures are in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C. In some example embodiments, the threshold temperature is one of 35° C., 40° C., 45° C., 50° C. and 60° C. In a specific embodiment, the threshold temperature is 40° C. Additionally, an example threshold temperature range may be from 0° C. to −80° C.

### Thermal Printing Process (with Ribbon)

The print head may be raised and lowered so that the print head is only in contact with ribbon 100 for the time (and distance) to provide a satisfactory print. By selectively raising and lowering the print head at predetermined intervals, less of the ribbon 100 may be used during print operations allowing more print operations per ribbon 100.

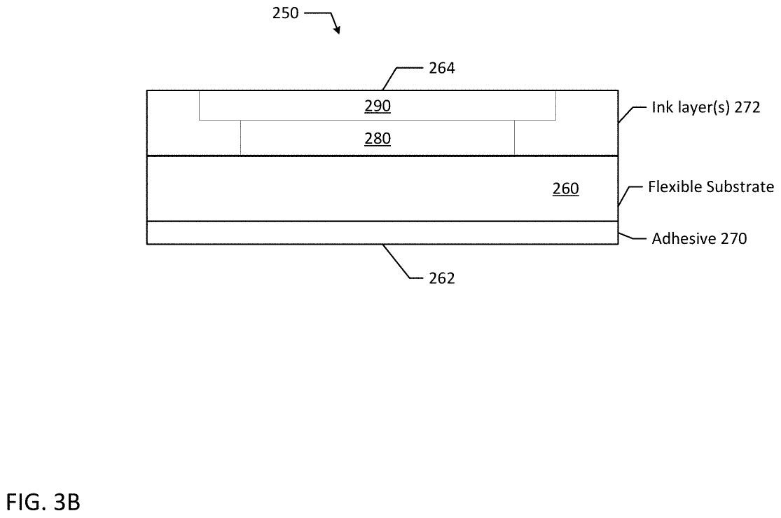

FIG. 4 illustrates an example printing process at various stages or print actions 300A to 300D. First and second print actions resulting in a first printed indicator 310a and a second printed indicator 310b are illustrated at stages 300A and 300B. For example, a first print action includes applying heat to the thermal transfer ribbon 100 via print head 305. As the print head 305 is pressed against the transfer ribbon 100 and into printable media 315, an environmental exposure indicator, such as a temperature exposure indicator 310a is printed on printable media 315. The ribbon 100 is advanced along the travel direction (e.g., print head 305 may be stationary) and the print head 305 may press ribbon 100 into printable media 315 again to form a second environmental exposure indicator, such as a temperature exposure indicator 310b. After a print operation, the ribbon 100 may include a cavity where one or more of the layers (e.g., binding layer 106) has been thermally applied to the printable media 315. For example, indicators 310a, 310b correspond to cavities 312a, 312c respectively. The printing actions may be selectively spaced along the ribbon 100 to allow portions of the ribbon 100 neighboring a print action to properly cool before that portion of ribbon is used for printing.

For example, as illustrated in FIG. 4, the print head 305 may utilize a “print, space, space” approach that skips two print regions on the ribbon per print to allow sufficient ribbon space between each print action. As illustrated in stage 300C, after reaching the end of ribbon 100, the ribbon 100 may be run in the reverse direction to complete two additional printing operations or actions thereby printing indicators 310c and 310d and leaving respective cavities 312c and 312d on ribbon 100. A controller may coordinate print locations such that the indicator 310c is printed in one of the space regions from the first pass (e.g., the last space in the first pass is where the printing starts for second pass in the reverse direction).

Again as illustrated at stage 300D, after reaching the end of ribbon 100, the ribbon 100 may run in the reverse direction (e.g., to the left) to complete two additional printing operations or actions thereby printing indicators 310e and 310f and leaving respective cavities 312e and 312f on ribbon 100. A controller may coordinate print locations such that the indicator 310e is printed in the last remaining space region (e.g., between cavity 312a and 312d) from the first pass and second pass. It should be appreciated that other printing patterns and/or controls may be used. For example, the printer may utilize a “print, space, print, space” pattern. In other examples, the ribbon may me moved transversely (e.g., into and out of the page) for subsequent printing operations to utilize additional dynamic or active ink from the ribbon 100.

The print head 305 in FIG. 4 may be a near edge print head. For example, indicators may be printed from the thermal transfer ribbon using a thermal transfer printer with near edge print heads for high-speed applications. For high-speed applications, the transfer ribbon 100 may include higher percentages of reactive components in the ink layer such that the ink later is thinner allowing heat to transfer through the ribbon more rapidly. In other examples, the ribbon may include an adhesive ink layer in a pattern matching the intended pattern on the product, that has been formed by die cutting a solid coating of indicating ink on a separate carrier followed by transfer to the release coated carrier 104. This construction separates the forming of the desired ink pattern from the transfer process, which facilitates high-speed transfer. This also improves start and end edge quality of the transfer printed ink, which typically are degraded at high speed. In other examples, multiple print heads 305 may act on a single ribbon 100. For example, indicators 310a-f may be printed by one or more print heads 305.

Referring back to FIGS. 1, 2A, 2B and 2C, the binding layer 106 or the indicator material layer 108 may comprise patterns or may be selectively coated on the ribbon 100. For example, the ribbons 100 may be selectively coated with multiple bands of different materials (e.g., environmental exposure indicator materials) and different print heads 305 may be configured to print specific materials placed on the ribbon 100. The binding layer 106 or the indicator material layer 108 may comprise patterns or may be selectively coated on the ribbon 100. For example, the binding layer 106 or the indicator material layer 108 may be selectively coated on the ribbon 100 to reduce waste of the environmental exposure indicator material.

During a thermal printing process, heat from a thermal print head passes through the backing substrate 104 and the binding layer 106 or indicator material layer 108, depending on the ribbon configuration. Under the same process conditions (e.g., same print head, same temperature, same coating and carrier properties), less heat passes through a thick binding layer 106 or indicator material layer 108 than a thin binding layer 106 or indicator material layer 108. Thus, the adhesive in either the adhesive layer 110 or the binding layer 106 may be selected based on process parameters. For thicker indicator material layers 108, adhesives with lower activation temperatures should be selected to ensure proper adhesion of the binding layer 106 or indicator material layer 108 to the printable media.

During the printing process, the print head 305 may be heated to a printing temperature, which may also be referred to as a print temperature or a heated thermal transfer temperature. In an example, the heated thermal transfer temperature is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C. For example, the print head 305 may be configured to heat a portion of the thermal transfer ribbon 100 or direct thermal print media to a one of the thermal transfer temperatures discussed above.

### Labels (e.g., Direct Thermal Label)

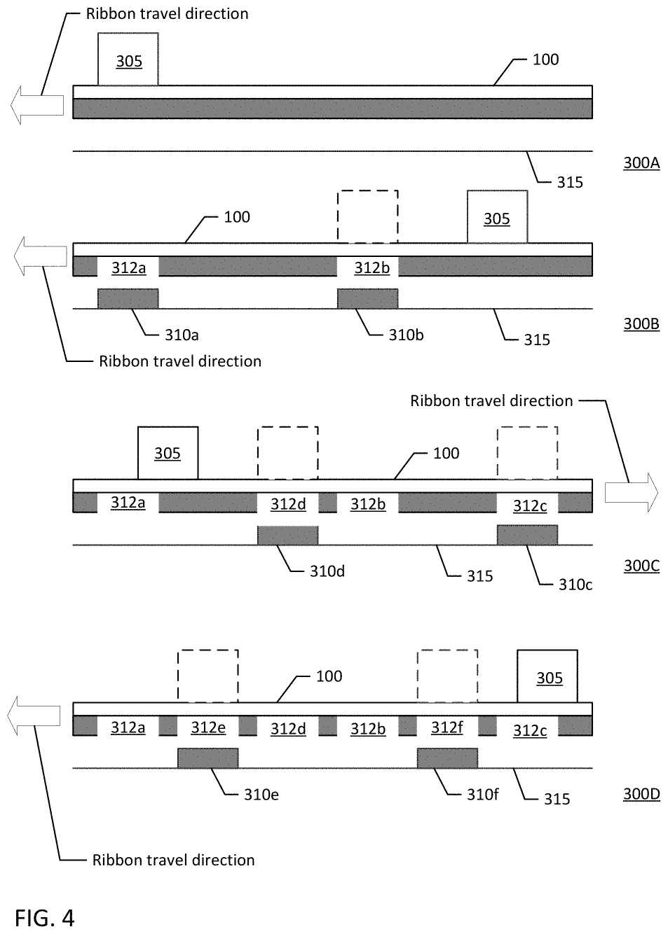

FIG. 5 illustrates a label 400 configured to indicate temperature exposure above a threshold temperature. In an example, label 400 includes a substrate 410 with a first side 412 and a second side 414. The first side 412 may comprise a printable area and an environmental exposure indicator material. In an example, the environmental exposure indicator material may be a temperature exposure indicator material, such as (a) an irreversible thermochromic indicator material configured to change color state in response to a temperature above the threshold temperature; (b) a reversible thermochromic indicator material configured to change color state in response to a temperature above the threshold temperature; (c) a reversible thermochromic indicator material configured to change color state in response to a temperature below the threshold temperature; (d) a semi-reversible thermochromic indicator material configured to change color state in response to a temperature above the threshold temperature, and to maintain the changed color state until the temperature falls below a second lower temperature threshold; or (e) an irreversible thermochromic indicator material configured to change color state responsive to cumulative heat exposure over time. In other example, the environmental exposure indicator material may be (f) an indicator material configured to change color state responsive to exposure to radiation; (g) an indicator material configured to change color state responsive to exposure to light of a predetermined wavelength; or (h) an indicator material configured to change color state responsive to exposure to humidity. In the illustrated example, an adhesive layer 430 is positioned adjacent the second side 414. Additionally, a coating layer 420 is positioned adjacent the first side 412 and the indicator material is between the coating layer 420 and the substrate 410.

The printable area may include one or more of the environmental exposure indicator materials discussed above, such as a direct thermochromic material or the irreversible thermochromic indicator material. In an example, the coating layer may be a resin of a thermal transfer ribbon 100 or a thermally printed overcoat. In another example, the coating layer 420 may be a varnish.

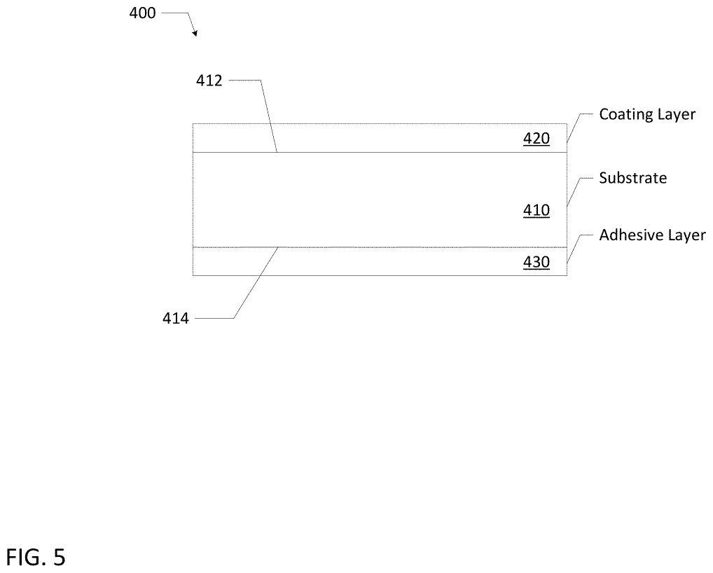

FIGS. 6A, 6B and SC illustrate an example embodiment of a direct thermal label 500. In an example, the direct thermal label 500 may be created from thermal paper stock or a thermal paper substrate 210 that has an environmental exposure indicator applied thereon. For example, the environmental exposure indicator may be a reversible thermochromic temperature indicator, which may be applied in an indicator material layer 220 over the thermal paper substrate 210. At room temperature, the thermochromic temperature indicator may appear black or another solid dark color (see FIG. 6A) at room temperature and may change to another color state (e.g., colorless) at temperatures above 40° C. The label 500 may be created by imaging the thermal paper substrate 210 with the thermochromic temperature indicator 510 applied thereon with a barcode symbol 520. The barcode symbol 520 may be imaged without activating color change in the temperature indicator 510, even though the print temperature utilized to image the barcode symbol 520 is higher than the activation temperature (e.g., 40° C.) of the temperature indicator 510.

If the label 500 is exposed to a temperature above the activation temperature of 40° C., as illustrated in FIG. 6B, the reversible thermochromic temperature indicator 510 changes from a solid dark color to a colorless state, thereby revealing the previously imaged barcode symbol 520. Then, when the label 500 is exposed to temperatures below the activation temperature of 40° C., as illustrated in FIG. 6C, the reversible thermochromic temperature indicator 510 changes from the colorless state back to a solid dark color, thereby masking or hiding the previously imaged barcode symbol 520.

### Methods and Product by Process

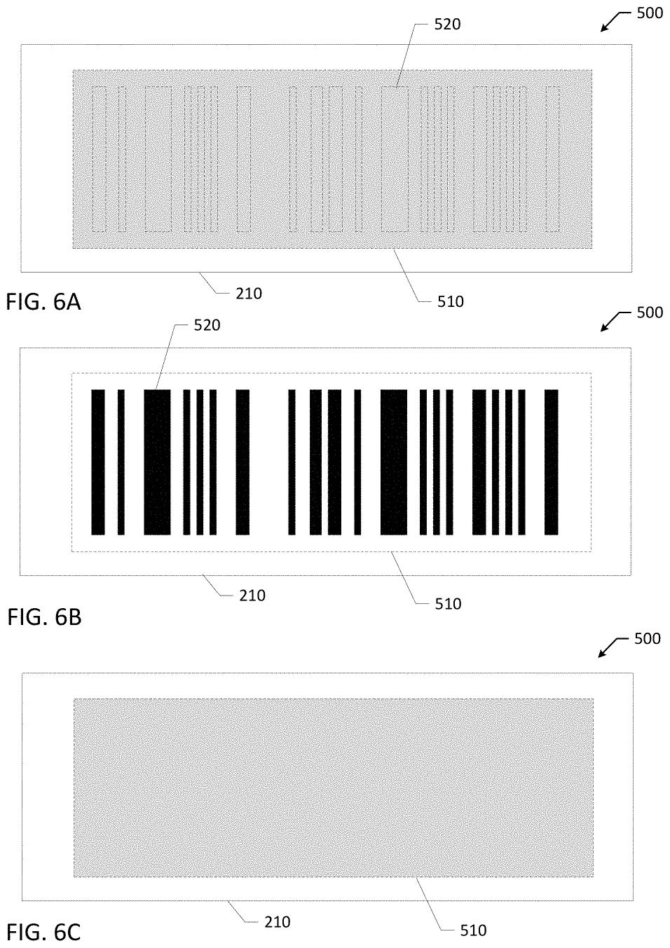

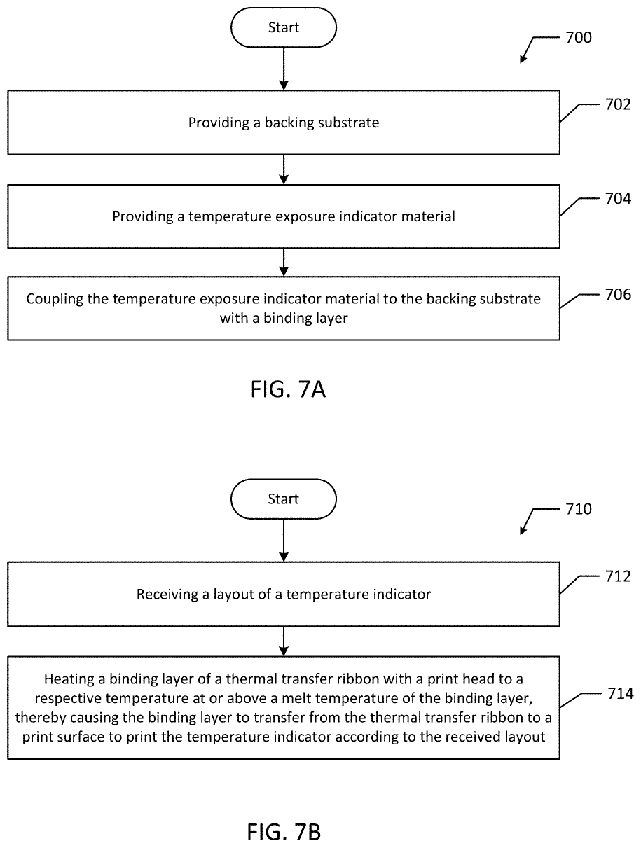

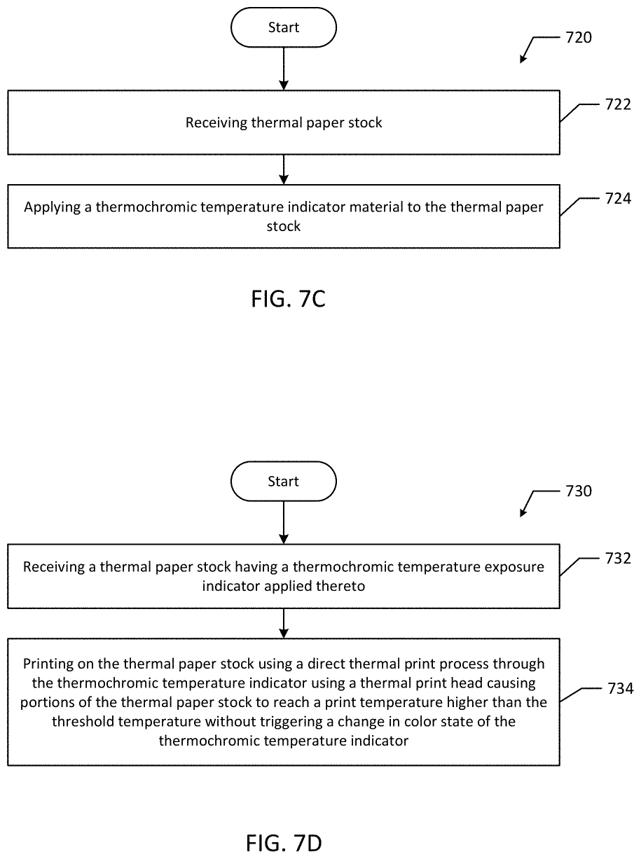

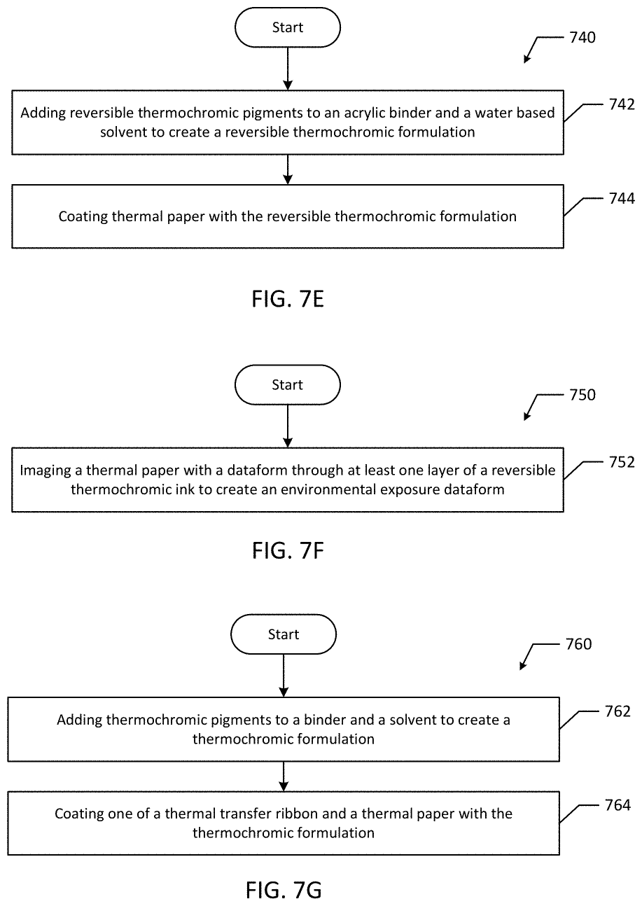

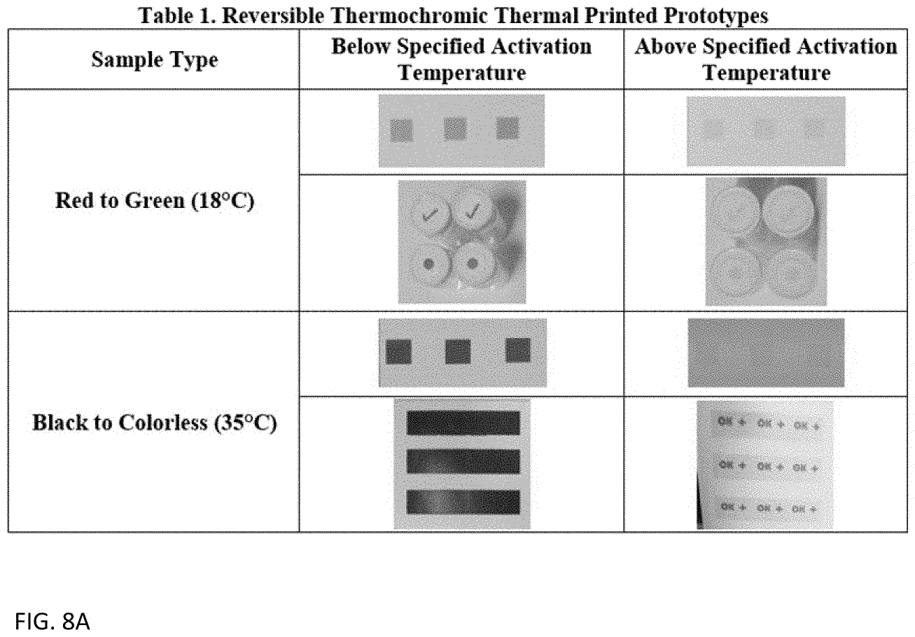

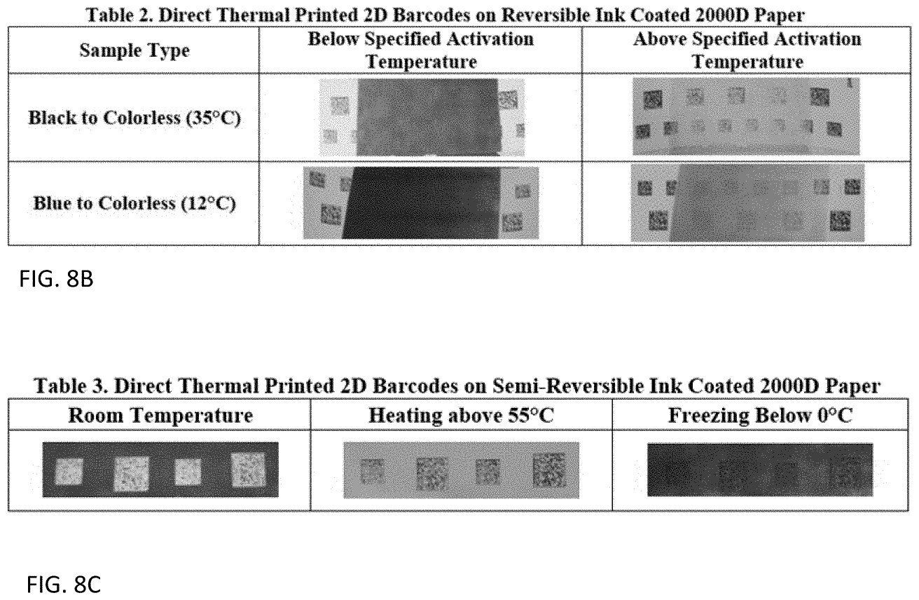

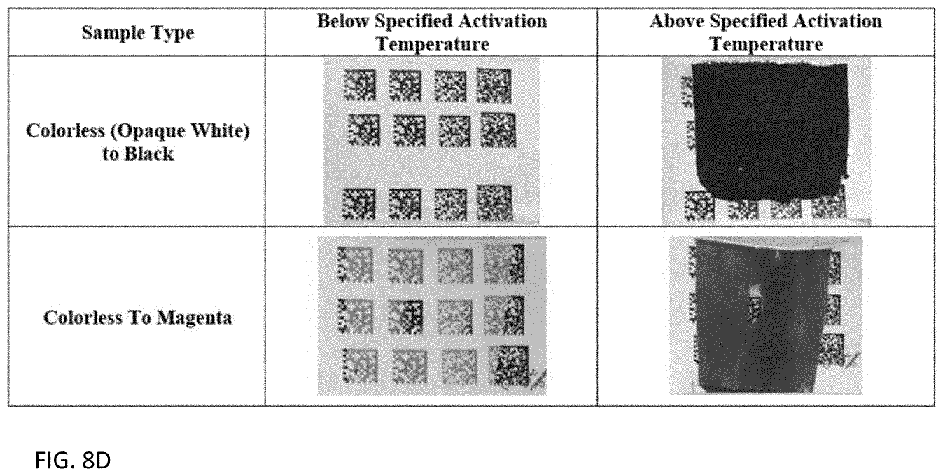

FIG. 7A illustrates a flowchart of an example method 700 for manufacturing a thermal transfer ribbon, according to an example embodiment of the present disclosure. Although the example method 700 is described with reference to the flowchart illustrated in FIG. 7A, it will be appreciated that many other methods of performing the acts associated with the method 700 may be used. For example, the order of some of the blocks may be changed, certain blocks may be combined with other blocks, blocks may be repeated, and some of the blocks described are optional.

The example method 700 may include providing a backing substrate (block 702). The backing substrate may be a blank thermal transfer ribbon. Additionally, method 700 may include providing a temperature exposure indicator material (block 704). The temperature exposure indicator material may be configured to change color state in response to temperature exposure above a threshold temperature. Method 700 may also include coupling the temperature exposure indicator material to the backing substrate with a binding layer (block 706). For example, the temperature exposure indicator material may be coupled to the backing substrate with a binding layer. The binding layer may be configured to release the temperature exposure indicator material to a printable media when heated by a print head. In an example, the binding layer has a higher melt temperature than the threshold temperature.

FIG. 7B illustrates a flowchart of an example method 710 for applying a temperature indicator to a print surface with a thermal transfer ribbon, according to an example embodiment of the present disclosure. Although the example method 710 is described with reference to the flowchart illustrated in FIG. 7B, it will be appreciated that many other methods of performing the acts associated with the method 710 may be used. For example, the order of some of the blocks may be changed, certain blocks may be combined with other blocks, blocks may be repeated, and some of the blocks described are optional.

The example method 710 may include receiving a layout of a temperature indicator (block 712). For example, a printer may be loaded with a thermal transfer ribbon having a backing substrate and a temperate exposure indicator material coupled to the substrate via a binding layer. The printer may receive a layout of the temperature indicator. In an example, the temperature indicator is to be formed by the temperature exposure indicator material of the binding layer. In an example, the temperature exposure indicator material is configured to change color state in response to a temperature exposure above or below a predetermined threshold temperature.

Method 710 may also include heating the binding layer of a thermal transfer ribbon with a print head to a respective temperature at or above a melt temperature of the binding layer, thereby causing the binding layer to transfer from the thermal transfer ribbon to a print surface to print the temperature indicator according to the received layout (block 714). In an example, the melt temperature of the binding layer is higher than the threshold temperature.

FIG. 7C illustrates a flowchart of an example method 720 for making temperature exposure indicator printing stock, according to an example embodiment of the present disclosure. Although the example method 720 is described with reference to the flowchart illustrated in FIG. 7C, it will be appreciated that many other methods of performing the acts associated with the method 720 may be used. For example, the order of some of the blocks may be changed, certain blocks may be combined with other blocks, blocks may be repeated, and some of the blocks described are optional.

The example method 720 may include receiving a thermal paper stock (block 722). Additionally, method 720 may also include applying a thermochromic temperature indicator material to the thermal paper stock (block 724). For example, the thermochromic temperature indicator material may be applied as a top layer to the thermal paper stock. The thermochromic temperature indicator material may be configured to change color state in response to reaching a temperature that is lower than the printing temperature of the thermal paper stock.

FIG. 7D illustrates a flowchart of an example method 730 for making a temperature exposure indicator, according to an example embodiment of the present disclosure. Although the example method 730 is described with reference to the flowchart illustrated in FIG. 7A, it will be appreciated that many other methods of performing the acts associated with the method 730 may be used. For example, the order of some of the blocks may be changed, certain blocks may be combined with other blocks, blocks may be repeated, and some of the blocks described are optional.

The example method 730 may include receiving a thermal paper stock having a thermochromic temperature exposure indicator applied thereon (block 732). In an example, the thermochromic temperature indicator is configured to change color state above a threshold temperature. Method 730 also includes printing on the thermal paper stock using a direct thermal print process through the thermochromic temperature indicator using a thermal print head causing portions of the thermal paper stock to reach a print temperature higher than the threshold temperature without triggering a change in the color state of the thermochromic temperature indicator (block 734).

FIG. 7E illustrates a flowchart of an example method 740 for making an environmental exposure thermal paper, according to an example embodiment of the present disclosure. Although the example method 740 is described with reference to the flowchart illustrated in FIG. 7E, it will be appreciated that many other methods of performing the acts associated with the method 740 may be used. For example, the order of some of the blocks may be changed, certain blocks may be combined with other blocks, blocks may be repeated, and some of the blocks described are optional.

The example method 740 may include adding a reversible thermochromic pigment(s) to an acrylic binder and a water based solvent to create a reversible thermochromic formulation (block 742). In an example, the acrylic binder may be a clear, viscous acrylic resin solution, such as Ottopol 25-30 provided by Gellner Industrial. Additionally, the water based solvent may be water. Method 640 may also include coating thermal paper with the reversible thermochromic formulation (block 744). In an example, the thermochromic formulation may be between 20% and 30% (e.g., weight percent) thermochromic pigment(s). Additionally, the formulation may be between 40% and 50% (e.g., weight percent) acrylic binder. In one example, the thermochromic formulation may be between 24% and 26% (e.g., weight percent) thermochromic pigment(s) and between 44% and 49% (e.g., weight percent) acrylic binder. The thermochromic formulation may have a viscosity (cps) between 150 cps and 300 cps and a yield stress between 3.0 dyne/cm² and 17 dyne/cm².

FIG. 7F illustrates a flowchart of an example method 750 for making an environmental exposure dataform, according to an example embodiment of the present disclosure. Although the example method 750 is described with reference to the flowchart illustrated in FIG. 7F, it will be appreciated that many other methods of performing the acts associated with the method 750 may be used. For example, the order of some of the blocks may be changed, certain blocks may be combined with other blocks, blocks may be repeated, and some of the blocks described are optional.

The example method 750 may include imaging a thermal paper with a dataform through at least one layer of a reversible thermochromic ink to create an environmental exposure dataform (block 752). The reversible thermochromic ink may be configured to change color state from a first state or color (e.g., blue) to a second state (e.g., colorless) or color in response to temperature exposure above a threshold temperature. In an example, the threshold temperature is 18° C. The layer of the reversible thermochromic ink may be applied to the thermal paper as described in method 740 above.

FIG. 7G illustrates a flowchart of an example method 760 for making an environmental exposure thermal transfer ribbon, according to an example embodiment of the present disclosure. Although the example method 760 is described with reference to the flowchart illustrated in FIG. 7G, it will be appreciated that many other methods of performing the acts associated with the method 760 may be used. For example, the order of some of the blocks may be changed, certain blocks may be combined with other blocks, blocks may be repeated, and some of the blocks described are optional.

The example method 760 may include adding a thermochromic pigment(s) to a binder and a solvent to create a thermochromic formulation (block 762). The binder may be an acrylic binder. Additionally, the solvent may be a water based solvent. In another example, the binder may be nitrocellulose and the solvent may be EEP/IPA. Additionally, method 760 includes coating a thermal transfer ribbon or a thermal paper with the thermochromic formulation (block 764). For example, the thermochromic formulation may be applied to any of the thermal transfer ribbons or thermal papers described herein.

It should be appreciated that the formulations (e.g., environmental indicator formulations or thermochromic formulations), environmental indicators (e.g., temperature indicators), and substrates or print media (e.g., thermal transfer ribbons and direct thermal paper) may have one or more properties described herein. Additionally, the methods above may be adapted to create each of the inks, formulations, etc. from the experimental results discussed below.

### EXPERIMENTAL RESULTS

Thermochromic pigments were used to prepare specific formulation matrices, allowing them to be used in various printing methods. Water-based formulations were suitable for flexo printing and coatings made onto direct thermal print paper. In some cases, certain solvents were shown to be incompatible with direct thermal papers as the solvents interacted with the paper components. Solvent-based formulations were suitable for coatings made onto ribbons for thermal transfer printing.

Thermochromic pigments must have a small particle size in order to be used in flexo printing applications (ideally between 3-6 um). The pigments can be added to both water and solvent based systems. However, solvents must be selected appropriately so as not to damage the microcapsule structure, thereby affecting the reversible color changing characteristics.

Work was done to evaluate pigment stability in different solvents, including acetone, methyl ethyl ketone (“MEK”), toluene, butyl alcohol, and IPA (MS19002 report). Specifically, thermochromic pigments were obtained from Atlanta Chemical Engineering, New Color Chemical, and Glitter Unique and were dispersed in different solvents. The results indicated that toluene and butyl alcohol are more compatible with reversible thermochromic pigments than the acetone and MEK.

Solvent Compatibility of Thermochromic Pigments—Experiment

The pigments from Atlanta Chemical Engineering, New Color Chemical, and Glitter Unique were added to a glass vial to prepare a 2% pigment in 5 g of solvent formulation. After at least 30 minutes on an orbital shaker at room temperature, the pigments appeared to be well dissolved in each solvent (acetone, MEK, toluene, and butyl alcohol).

The Atlanta Chemical Engineering pigment changes from blue to pink above an activation temperature of 12° C. and has a manufacturer stated particle size between 2 μm and 15 μm. In order to show the appropriate color change, the samples were placed inside a freezer for 15 minutes. The pigment samples in Acetone appeared cloudy at room temperature and did not show color change to blue when cooled inside the freezer. Additionally, the pigments dissolved in MEK showed a cloudy blue color upon cooling. The above results indicated that the thermochromic pigment was compromised when dissolved in acetone and MEK.

The Glitter Unique pigment changes from purple to green above an activation temperature of 22° C., but did not have a manufacturer stated particle size. The pigment samples in Acetone appeared cloudy at room temperature and did not show color change to purple, which indicated that the thermochromic pigment was compromised when dissolved in acetone.

The New Color Chemical pigment changes from black to pink above an activation temperature of 15° C. and has a manufacturer stated particle size between 2 μm and 6 μm. The pigment samples in Acetone and MEK appeared cloudy at room temperature. The pigment in acetone did not show color change to dark purple or black when cooled inside the freezer. The pigment samples in MEK changed color upon cooling, but appeared tan in color, not dark purple or black. The above results indicated that the thermochromic pigment was compromised when dissolved in acetone and MEK.

The pigments from each manufacturer maintained color change characteristics as specified in toluene and butyl alcohol. Additionally, the thermochromic pigments added to water showed good stability.

To obtain acceptable flexo coating and suitable direct thermal printing characteristics, the appropriate water-based binder must be selected. Examples and details of some of the water-based flexo inks are described in Table 3 and the paragraphs following Table 3 below. Water-based binders with a neutral pH (7) are recommended, avoiding acidic or alkaline binders as they could damage the microcapsule structure. For example, Neocryl BT-24 (pH 5.3) was shown not to be suitable, as flexo coating was streaky and non-uniform. However, the Neocryl A-1052 (pH 8.5) provides a much more uniform coating.

Additionally, the appropriate pigment/binder (“P/B”) ratio and viscosity must be identified for a smooth, uniform coating. Inks having a high P/B ratio appear clumpy and non-uniform. For example, Ottopol 25-30 was used along with 35° C. black to colorless pigment to prepare formulations with P/B: 3.0, 1.5, and 1.0, coated onto direct thermal paper (2000D) using flexo handproofer. Inks with a P/B ratio of 3.0 resulted in uneven, rough coating that was non-uniform. Decreasing the P/B ratio to 2.0 improves the coating and the optimum P/B ratio was shown to be between 2.0 and 1.5. The binder providing the best results was Ottopol 25-30, but Epotuf 91-263 also provided acceptable results.

For solvent-based coatings made for thermal transfer ribbons, an appropriate binder must be selected that has desired adhesive characteristics, and the ink must be applied onto the ribbon at a suitable thickness (and ideal pigment concentration as a ratio or percent of total percent solids) in order to transfer completely and uniformly onto the substrate during the thermal printing process. Formulations made using a water-based binder system neither coat homogeneously nor show good transfer characteristics. The 35° C. black to colorless was coated with the water-based binder system yielding poor results. Ribbons coated with formulations using Joncryl 538A emulsion (45% solids) did not correctly transfer print images.

Well performing adhesives will dry without tackiness while maintaining good flexibility to minimize flaking from the substrate. The adhesive needs to melt, release from the ribbon, and adhere to substrate in the printing process. The melt temperature needs to be in a range attainable by the print head the melted image area needs greater adhesion with the substrate than the release coating of the ribbon.

As illustrated below in Table 2, various thermochromic pigments showing reversible color change were added to an acrylic resin/solvent matrix containing a small amount of TiO₂ for opacity. The formulations were coated on a blank thermal ribbon and the ribbons were then used to thermally transfer the thermochromic ink onto samples of 2059 paper label stock. The samples were laminated, die-cut, and tested for color changing response. The ribbons coated with an optimized formation having approximately 58% solids using a No. 12 Mayer rod demonstrated that thermochromic inks can be thermally transfer printed. The results confirmed that the thermochromic prototypes show a reversible color change that is unambiguous within ±2° C. of the manufacturer's stated activated temperature.

TABLE 1
Thermochromic Pigment Formulations

| Ink Coating | Flexo | Direct Thermal | Thermal Transfer |
|---|---|---|---|
| Thermochromic | Micro-encapsulated | Micro-encapsulated | Micro-encapsulated |
| Pigments | leuco-dye pigments | leuco-dye pigments | leuco-dye pigments |
| Pigment | <10 um | <10 um | <10 um |
| particle size | | | |
| Binders | Neocryl A-1052; | Neocryl A-1052; | Joncryl 682; |
| | Neocryl BT-24; | Neocryl BT-24; | Joncryl 538A |
| | Epotuf 91-263; | Epotuf 91-263; | (45% solids); |
| | Ottopol 25-50E; | Ottopol 25-50E; | Neocryl B-818 |
| | Ottopol 25-30 | Ottopol 25-30 | |
| Solvents | Water; | Water | IPA; |
| | n-Propanol | | Butyl Alcohol |
| Other Additives | Kaolin; | Kaolin; | TiO2; |
| | TiO₂; | TiO₂; | Sipernat 22LS; |
| | Tego Twin 4100; | Tego Twin 4100; | silica |
| | Tego Foamex 1488; | Tego Foamex 1488; | |
| | Tego Gide 406 | Tego Gide 406 | |

TABLE 2
Thermochromic Ink Formulations used For Coating on Thermal Transfer Ribbon

| | | | | | | Ribbon | |
|---|---|---|---|---|---|---|---|
| | Formulation Details | | | | | Coating | |
| Pigment and | Sample | TC | Joncryl | | | Thickness/Coat | |
| Supplier | ID | Pigment | 682 | Solvent | TiO₂ | Weight | Result |
| 25° C. Black | 1253-1 | 37% | 33% | 27.5% | 2.5% | Meyer | No |
| to Yellow | C1 | | | Butyl | | Rod No. | transfer |
| Pigment | | | | Alcohol | | 30 | |
| (Atlanta Chemical | 1253-1 | 18.5% | 34% | 46% | 1.25% | Meyer | Good |
| Engineering | C1 (Diluted) | | | Butyl | | Rod No. | transfer |
| “ACE”) | | | | Alcohol | | 12 | |
| | 1253-3 B | 20% | 35% | 42% | 3.0% | Meyer | Good |
| | | | | Butyl | | Rod No. | transfer |
| | | | | Alcohol | | 12 | |
| 35° C. Black | 560-19 | 30% | 33% | 35% | 2.0% | 5.1 gsm | Good |
| to Colorless | Trial | | | IPA | | 8.6 gsm | transfer |
| (ACE) | | | | | | 10.2 gsm | |
| 18° C. Red to | 560-19 | 30% | 33% | 35% | 2.0% | 5.1 gsm | Good |
| Green | Trial | | | IPA | | 8.6 gsm | transfer |
| (ACE) | | | | | | 9.3 gsm | |
| 22° C. Red to | 1253-2 | 35% | 32% | 27% | 5.7% | Meyer | N/A |
| Green | | | | Butyl | | Rod No. | |
| | | | | Alcohol | | 12 | |
| Glitter | 1253-2 | 17.7% | 33.5% | 46% | 2.8% | Meyer | Good |
| Unique | B2 | | | Butyl | | Rod No. | transfer |
| | | | | Alcohol | | 12 | |
| | 1253-3A | 20% | 35% | 42% | 3.0% | Meyer | Good |
| | | | | Butyl | | Rod No. | transfer |
| | | | | Alcohol | | 12 | |

### Example I—Reversible Thermochromic—Thermal Transfer Ribbon

Reversible thermochromic indicator materials configured to change color state in response to a temperature above a threshold temperature were tested. In one example, the indicator materials were reversible thermochromic color changing pigments, obtained from Atlanta Chemical Engineering and Glitter Unique, that had different activation temperatures (e.g., threshold temperatures) and color changing properties, such as (1) EXAMPLE IA—a pigment that changes from red to green above a temperature of 18° C. obtained from Glitter Unique, (2) EXAMPLE IB—a pigment that changes from black to colorless above a temperature of 35° C. obtained from Atlanta Chemical Engineering (“ACE”), and (3) EXAMPLE IC—a pigment that changes from blue to colorless above a temperature of 12° C. obtained from LCR Hallcrest (i.e., WB Flexo Ink).

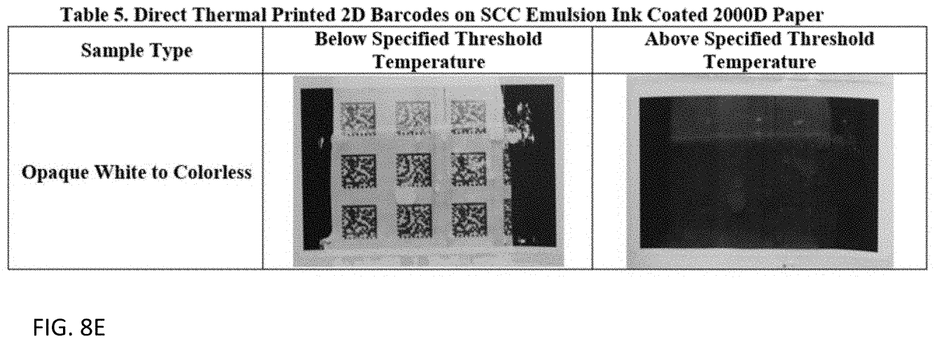

The pigments described above were added (approximately 18% to 25% weight percent) to formulate an indicator material, such as an ink, containing an acrylic binder (i.e., Joncryl 682 resin obtained from BASF) and an Isopropyl Alcohol (“IPA”) solvent obtained from Sigma Aldrich that was suitable for thermal transfer printing. The resulting indicator material was uniformly coated in a thin layer with a coat weight of approximately 5 gsm to 10 gsm onto a thermal transfer ribbon 100 having a back coating 102 and a release layer 109 using a reverse gravure pilot coater. The ribbon was an IIMAK, 4.5 micron film, thermal transfer ribbon with a backing layer of IIMAK WBE08700C at 0.06 gsm and a release coating of IIMAK WIS37UC at 0.54 gsm. The coated ribbon 100 was subsequently used on the Zebra ZT610 to thermal transfer print samples different patterns onto Z-Perform 2000T paper substrate. Additionally, thermal printed squares were made on Zebra 2000T labels covering over an existing a printed message to demonstrate “mask and reveal” text, as illustrated in FIG. 8A.

As illustrated in FIG. 8A, the red to green samples (EXAMPLE IA) were observed for appearance of red color under refrigerated conditions, inside an incubator at 5° C., and appearance of green color at room temperature. The black to colorless samples (EXAMPLE IB) were observed for appearance of dark color at room temperature and the disappearance of the dark color under high temperature conditions inside an incubator above 38° C.

As illustrated in FIG. 8B, the black to colorless samples (EXAMPLE IB) and blue to colorless samples (EXAMPLE IC) were used with direct thermal printed 2D barcodes on reversible ink coated Z-Perform 2000D paper. The blue to colorless samples were observed for appearance of blue color under refrigerated conditions, inside an incubator at 5° C., and the disappearance of the blue color at room temperature.

### Example II—Semi-Reversible Thermochromic—Direct Thermal

Semi-reversible thermochromic indicator materials configured to change color state in response to a temperature above the threshold temperature, and to maintain the changed color state until the temperature falls below a second lower temperature threshold were tested. In one example, a commercially available memory slurry having approximately 45% weight percent solids was obtained from United Mineral & Chemical Corporation (“UMC”), named TM-MSL Black (50C-0C) memory slurry ink, showing semi-reversible color change from black to colorless between 0° C. to 55° C. The memory slurry, in the form of an ink, was coated in a thin layer of approximately 12 μm onto direct thermal Z-Perform 2000D paper and then the coated paper was used to thermal print 2D barcodes.

As illustrated in FIG. 8C, at room temperature, the 2D barcodes are visible on the direct thermal Z-Perform 2000D paper, after heating above 55° C., the semi-reversible thermochromic indicator material changes to colorless and the entire portion of the direct thermal paper is visible. Then, when freezing below 0° C., the entire portion of the direct thermal paper appears black.

### Example III—Irreversible Thermochromic—Direct Thermal

Irreversible thermochromic indicator materials configured to change color state in response to a temperature above the threshold temperature were also tested. In an example, commercially available water-based inks that change from colorless or opaque white to colored (e.g., dark colored) and that have threshold temperatures at 65° C. and 85° C. were obtained. The 65° C. ink was obtained from LCR Hallcrest (Kromagen Magenta) and the 85° C. ink was also obtained from LCR Hallcrest (Kromagen Black). Each ink was coated (1.5 mil thickness of wet applied film) with a Bird film applicator bar onto a strip of direct thermal Z-Perform 2000D paper. The ink was allowed to dry at room temperature overnight. The sample strip of irreversible ink coated paper was then placed onto a Zebra ZT610 printer in “direct thermal” mode and 2D barcode images were successfully printed through the irreversible ink coating.

As illustrated in FIG. 8D, one sample (EXAMPLE IIIA) that changes from colorless (e.g., opaque white) to black was coated on the direct thermal Z-Perform 2000D paper. Below the specified activation or threshold temperature of 85° C., the imaged 2D barcodes are clearly visible on the direct thermal paper. Above the specified activation or threshold temperature, the imaged 2D barcodes appear masked by the irreversible thermochromic ink.

Another example (EXAMPLE IIIB) illustrated in FIG. 8D, shows the direct thermal Z-Perform 2000D paper with the colorless to magenta irreversible thermochromic ink coated on the paper (the ink is configured to change from colorless to magenta above a specified activation or threshold temperature of 65° C. Below, the specified activation temperature, the irreversible thermochromic ink is colorless and the imaged 2D barcodes are visible. As illustrated in the figure, the portions of the 2D barcode imaged under portion of the direct thermal paper coated with the irreversible thermochromic ink may appear magenta due to the ink being activated by the heat of the printing process. Once the sample (EXAMPLE MB) is exposed to a temperature above the activation or threshold temperature, the entire portion of the direct thermal paper coated with the irreversible thermochromic ink appears to be magenta.

### Example IV—SCC Emulsion Polymer Ink—Direct Thermal

As illustrated in FIG. 8E (Example IVA), an SCC emulsion polymer ink (with a 40° C. threshold) was coated with a Bird film applicator bar in a thin layer (1.5 mil thickness of wet applied film) over black flood print on Z-Perform 2000D thermal paper. Specifically, a direct thermal printed square pattern was imaged onto the Z-Perform 2000D paper using a Zebra ZT610 printer. The coated paper was then used to direct thermal print 2D barcodes over the SCC emulsion layer. Table 5, which is illustrated in FIG. 8E shows the appearance of the samples before heating (opaque white) and after heating>50° C., where the SCC emulsion ink changes to colorless and reveals the black printed substrate.

### Example V—SCC Emulsion Polymer Ink—Thermal Transfer Ribbon

In another example, a thermal transfer SCC formulation was prepared in such a way that allows the coating to uniformly transfer onto the substrate without flaking off (e.g., adequate adhesion characteristics). Well performing adhesives will dry without tackiness while maintaining sufficiently flexibility to minimize flaking. The adhesive needs to melt, release from the ribbon and adhere to the substrate in the printing process. The melt temperature needs to be in a range attainable by the print heat and the melted image area needs greater adhesion with the substrate than the release coating of the ribbon. Additionally, since the SCC polymer emulsion ink is irreversible, it is important that the thermal transfer printing occurs in a way that the ink is not compromised by the heat during the printing process. During experimentation, the aqueous emulsion adhesive mixtures (Joncryl 538A) did not coat the ribbon well or provide a usable ribbon after drying. Formulations of Joncryl/MEK/SCC emulsions were successfully coated onto the thermal transfer ribbon and 4 mm squares were printed onto black 2059 paper label stock or substrate.

Evaluation of 18° C. Reversible Thermochromic Pigments

Samples were obtained from ACE and Glitter Unique that transition from colorless to blue at an activation temperature of 18° C. The pigment powders were used to make both solvent-based screen ink and water-based flexo ink. The formulations are described below in Table 3 and Table 4.

TABLE 3
18° C. Blue-Colorless Reversible Water-Based Flexo Inks

| | | | | | Yield |
|---|---|---|---|---|---|
| Sample ID | % | | % | Viscosity | Strength |
| (supplier) | Pigment | Binder and Solvent | solids | (cps) | (dyne/cm²) |
| 1253-36 A | 26% | 44% Ottopol 25-30 | 45% | — | — |
| (ACE) | | (30% solids) in water | | | |
| 1253-37 A1 | 26% | 47% Ottopol 25-30 | 42% | 300 | 5.4 |
| (ACE) | | (30% solids) in water | | | |
| 1253-37 A2 | 24.5% | 49% Ottopol 25-30 | 41% | 261 | 3.2 |
| (Glitter Unique) | | (30% solids) in water | | | |
| TI21135 | 24% | — | 39% | 156 | 17 |
| (LCR Hallcrest) | | | | | |

TABLE 4
18° C. Blue-Colorless Reversible Solvent-Based Screen Inks

| | | | | | Yield |
|---|---|---|---|---|---|
| Sample ID | % | | % | Viscosity | Strength |
| (supplier) | Pigment | Binder and Solvent | solids | (cps) | (dyne/cm²) |
| 1253-36 B | 19% | 30% Nitrocellulose in | — | 4100 | 143 |
| (ACE) | | EEP/IPA | | | |
| 1253-36 B1 | 18% | 30% Nitrocellulose in | — | 2752 | 5.8 |
| (ACE) | | EEP/IPA | | | |
| 1253-36 B2 | 17% | 30% Nitrocellulose in | 37% | 2167 | 4.9 |
| (ACE) | | EEP/IPA | | | |
| 1253-37 B | 20% | 30% Nitrocellulose in | 46% | 3896 | 78 |
| (ACE) | | EEP/IPA | | | |
| 1253-37 B2 | 21% | 30% Nitrocellulose in | 46% | 4619 | 87 |
| (Glitter Unique) | | EEP/IPA | | | |

For the solvent-based screen inks, drawdowns were performed with Bird bars (1.5 mil, wet coat) to coat onto 2059 paper label stock. For the water-based flexo inks, drawdowns were performed with Harper QD flexo hand proofer with anilox roller (160 lpi/12.0 BCM) to coat onto Z-Perform 2000D paper. Sections of the drawdowns were used for testing on a TECA temperature control plate under controlled increasing and decreasing temperature conditions (e.g., 1.0° C. at 5 minute intervals) until full color change was observed. OD measurements (in cyan) were taken at each temperature interval using a 504 series densitometer.

Solvent Compatibility: each of the samples were assessed after 14 days to determine if the solvents damaged the thermochromic pigments. After 14 days, the pigments in each of the solvents demonstrated color change as expected, appearing colorless at room temperature and changing to dark blue upon exposure to refrigeration temperatures.

Hysteresis Loop Performance: the water-based flexo ink and solvent-based screen ink (1.5 mil, wet) coated drawdown samples were placed onto the surface of the TECA temperature control page at 9° C. and then left for 30 minutes, after which OD (cyan) measurements were taken. The temperature of the TECA was increased at 1.0° C. increments and the sample was measured for OD values after 5 minutes at each test temperature. Overall, the solvent screen ink at 1.5 mil (wet) coated onto 2059 paper label stock provides a much heavier coating than the multiple coats of water-based flexo ink. Additionally, coatings prepared using the 360 lpi/4.3 BCM anilox show the same color change behavior as the coatings made using the 160 lpi/12.0 BCM anilox. All the samples tested for color change under controlled increasing and decreasing temperature conditions demonstrated performance within the desired target specification: colorless (light blue) between 16.5° C. and 19.5° C. when warming from refrigeration, and reappearance of dark blue color at or below 12° C. All samples exhibited hysteresis loop behavior as expected, however the samples from ACE demonstrated sharper color change transition (i.e., steeper hysteresis curves) than ink containing pigment from Glitter Unique or LCR Hallcrest.

Temperature Cycling: three sections of the drawdown samples (1.5 mil, Bird bar drawdown of solvent screen ink made with ACE pigment) were placed into a Darwin Refrigerated Incubator at 5° C.±3° C. and left inside cold conditions for 30 minutes. After the initial 30 minutes of refrigeration, the samples (e.g., Sample A, Sample B, and Sample C) were exposed to different cycling conditions. Sample A was left continuously at refrigeration (inside the Darwin incubator at 5° C., Sample B was cycled between refrigeration (at 5° C.) and room temperature, holding for 30 minutes at each condition, and Sample C was cycled between refrigeration (at 5° C.) and 37° C., holding for 30 minutes at each condition.

The cycling test was conducted for a total of 48 hours, with one overnight exposure at refrigeration and another overnight exposure at a temperature above the stated activation temperature (i.e., room temperature or 37° C.). Throughout the cycling test, all samples showed acceptable visual color change, with the appearance of dark blue in refrigeration and disappearance of blue color upon warming to either room temperature or 37° C. on the TECA. After 48 hours, the samples were tested for color response under controlled increasing and decreasing temperature conditions on the TECA.

Conclusions: 18° C. reversible thermochromic pigment from ACE left at room temperature for 2 weeks dissolved in IPA, water, and EEP demonstrated color change as expected, appearing colorless at room temperature changing to dark blue upon exposure at refrigeration. This preliminary assessment confirmed that the microcapsule shell material is not negatively affected by exposure to these solvents. Additionally, controlled increasing/decreasing temperature testing performed on 18° C. blue-colorless reversible inks (solvent-based screen and water-based flexo) containing pigment from different suppliers confirmed the hysteresis loop performance characteristics of the reversible thermochromic material. Overall, the 1.5 mil solvent screen ink coated onto 2059 paper label stock provided a much heavier coating and subsequently a greater color contrast between dark blue and colorless states than the multiple (6×) coats of the water-based flexo ink. Results also showed that ink made with pigment from ACE demonstrate a sharper color change transition (i.e., steeper hysteresis curve) than ink containing pigment from Glitter Unique or LCR Hallcrest.

After 48 hours of temperature cycling between refrigeration and room temperature and refrigeration and 37° C., all samples tested showed no major differences in hysteresis loop performance behavior. All samples experiencing temperature cycling show similar performance to the control sample (no temperature cycling) and the sample stored continuously at refrigerated conditions for 48 hours.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it should be appreciated that the features of the dependent claims may be embodied in the systems, methods, and apparatus of each of the independent claims.

Many modifications to and other embodiments of the invention set forth herein will come to mind to one skilled in the art to which these inventions pertain, once having the benefit of the teachings in the foregoing descriptions and associated drawings. Therefore, it is understood that the inventions are not limited to the specific embodiments disclosed, and that modifications and other embodiments are intended to be included within the scope of the appended claims. Although specific terms are employed herein, they are used in a generic and descriptive sense only and not for purpose of limitation.

1. An environmental exposure thermal paper prepared by a process comprising the steps of:
adding reversible thermochromic pigments to an acrylic binder and a water based solvent to create a reversible thermochromic formulation, wherein the thermochromic formulation is configured to change color state from blue to colorless in response to temperature exposure above a threshold temperature of 18° C.; and
coating thermal paper with the reversible thermochromic formulation.

2. The environmental exposure thermal paper of claim 1, wherein the acrylic binder is a clear, viscous acrylic resin solution.

3. The environmental exposure thermal paper of claim 1,
wherein the thermochromic formulation includes between about 24 and about 26 weight percent of thermochromic pigments.

4. The environmental exposure thermal paper of claim 1,
wherein the thermochromic formulation includes between about 44 weight percent and 49 weight percent of the acrylic binder.

5. The environmental exposure thermal paper of claim 1, wherein the thermochromic formulation has a viscosity (cps) between 150 cps and 300 cps.

6. (canceled)

7. The environmental exposure thermal paper of claim 1, wherein the thermochromic formulation has a yield stress between 3.0 dyne/cm² and 17 dyne/cm².

8. An environmental exposure dataform prepared by a process comprising the steps of:
imaging a thermal paper with a dataform through at least one layer of a reversible thermochromic ink to create the environmental exposure dataform, wherein the reversible thermochromic ink is configured to change color state from blue to colorless in response to temperature exposure above a threshold temperature of 18° C.

9. The environmental exposure dataform of claim 8, wherein the reversible thermochromic ink is formed by mixing thermochromic pigments with an acrylic binder and a water based solvent.

10. (canceled)

11. The environmental exposure dataform of claim 8, wherein the thermochromic ink includes between about 24 and about 26 weight percent of thermochromic pigments.

12. The environmental exposure dataform of claim 8, wherein the thermochromic ink includes between about 44 weight percent and 49 weight percent of the acrylic binder.

13. The environmental exposure dataform of claim 8, wherein the thermochromic ink has a viscosity (cps) between 150 cps and 300 cps.

14. (canceled)

15. The environmental exposure dataform of claim 8, wherein the thermochromic ink has a yield stress between 3.0 dyne/cm² and 17 dyne/cm².

16. A label comprising:
a flexible substrate, the flexible substrate comprising a first side and a second side, wherein
the first side is an adhesive,
the second side is configured to be printed with a first visible mark, and
the second side having a second printed, overlapping mark, wherein the overlapping mark is configured to change opacity below a first transition temperature to obscure the visible mark.

17. The label of claim 16, wherein the overlapping mark changes opacity from opaque to transparent at a second transition temperature, the second transition temperature being the same as the first transition temperature.

18. The label of claim 16, wherein the overlapping mark changes from opaque to transparent at a second transition temperature, the second transition temperature being warmer than the first transition temperature.

19. The label of claim 17, wherein the adhesive is configured to attach the label to a vial, and the second transition temperature is configured to change opacity when a liquid within the vial reaches 18° C.

20. (canceled)

21. (canceled)

22. The label of claim 16, wherein the visible mark is light blue and the overlapping mark, when opaque, is dark blue.

23. The label of claim 16, wherein the flexible substrate is a thermal paper substrate configured to be printed by a direct thermal print process with a heated thermal print head, the thermal paper substrate having an imaging temperature and adapted to change color when heated by the heated thermal print head to or above the imaging temperature.

24. The label of claim 23, further comprising an environmental exposure indicator provided on the thermal paper substrate, the environmental exposure indicator comprising an environmental exposure indicator material configured to change color state in response to a temperature exposure above a predetermined threshold temperature, which is below the imaging temperature.

25. The label of claim 24, wherein the environmental exposure indicator is the overlapping mark.

26. The label of claim 24, wherein the environmental exposure indicator material is a dye encapsulated in a matrix.

27. The label of claim 24, wherein the environmental exposure indicator material is selected from the group consisting of:
(a) an irreversible thermochromic indicator material configured to change color state in response to a temperature above the threshold temperature;
(b) a reversible thermochromic indicator material configured to change color state in response to a temperature above the threshold temperature;
(c) a reversible thermochromic indicator material configured to change color state in response to a temperature below the threshold temperature;
(d) a semi-reversible thermochromic indicator material configured to change color state in response to a temperature above the threshold temperature, and to maintain the changed color state until the temperature falls below a second lower temperature threshold; and
(e) an irreversible thermochromic indicator material configured to change color state responsive to cumulative heat exposure over time.

28. (canceled)

29. The label of claim 27, wherein the environmental exposure indicator material is (a), and the flexible substrate is configured for imaging a dataform on the flexible substrate at an imaging temperature above the threshold temperature without the environmental exposure indicator material changing color state.

30. (canceled)

31. The label of claim 27, wherein the environmental exposure indicator material is (a), and the environmental exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

32. The label of claim 24, wherein the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

33. The label of claim 32, wherein the threshold temperature is one of 35° C., 40° C., 45° C., 50° C. and 60° C.

34. The label of claim 32, wherein the threshold temperature is 40° C.

35. The label of claim 24, wherein the print head has a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

36. (canceled)

37. The label of claim 24, wherein the environmental exposure indicator material further comprises a leuco dye, a micro-encapsulated leuco-dye, an SCC Polymer, a water-based SCC polymer emulsion, a diacetylene, an alkane, a wax, an ester or combinations thereof.

38. (canceled)

39. The label of claim 37, wherein the environmental exposure indicator material has a particle size between 400 nm and 600 nm.

40. The label of claim 24, wherein the environmental exposure indicator material has a concentration, in a layer applied to the direct thermal printer stock, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

41. The label of claim 27, wherein the environmental exposure indicator material is (c) and the second lower temperature threshold is in the range selected from the group consisting of <4° C., <0° C., <−5° C., <−10° C. and <−15° C.

42. The label of claim 24, wherein the environmental exposure indicator material is provided on the thermal paper substrate as an ink slurry.

43. (canceled)

44. The label of claim 42, wherein the ink slurry is configured to at least one of (1) change color state from black to colorless above the threshold temperature of 55° C., and to maintain the changed color state until the temperature falls below a second lower temperature threshold of 0° C., (2) change color state from colorless to black above the threshold temperature of 65° C., and (3) change color state from colorless to magenta above the threshold temperature of 85° C.

45. (canceled)

46. (canceled)

47. The label of claim 24, wherein the environmental exposure indicator material is provided on the thermal paper substrate as an SCC emulsion.

48. (canceled)

49. The label of claim 47, wherein the SCC emulsion is configured to change color state from opaque white to colorless above the threshold temperature of 40° C.

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. A direct thermal printer stock including an environmental exposure indicator material, comprising:
a thermal paper substrate configured to be printed by a direct thermal print process with a heated thermal print head, the thermal paper substrate having an imaging temperature and adapted to change color when heated by the heated thermal print head to or above the print temperature; and
an environmental exposure indicator provided on the thermal paper substrate, the temperature exposure indicator comprising the environmental exposure indicator material configured to change color state in response to a temperature exposure above a predetermined threshold temperature, which is below the print temperature.

70. The direct thermal printer stock of claim 69, wherein the environmental exposure indicator material is a dye encapsulated in a matrix.

71. The direct thermal paper stock claim 69, wherein the environmental exposure indicator material is selected from the group consisting of:
(a) an irreversible thermochromic indicator material configured to change color state in response to a temperature above the threshold temperature;
(b) a reversible thermochromic indicator material configured to change color state in response to a temperature above the threshold temperature;
(c) a reversible thermochromic indicator material configured to change color state in response to a temperature below the threshold temperature;
(d) a semi-reversible thermochromic indicator material configured to change color state in response to a temperature above the threshold temperature, and to maintain the changed color state until the temperature falls below a second lower temperature threshold; and
(e) an irreversible thermochromic indicator material configured to change color state responsive to cumulative heat exposure over time.

72. (canceled)

73. The direct thermal printer stock of claim 71, wherein the environmental exposure indicator material is (a), and the direct thermal printer stock is configured for imaging a dataform on the direct thermal printer stock at a print temperature above the threshold temperature without the environmental exposure indicator material changing color state.

74. The direct thermal printer stock of claim 71, wherein the environmental exposure indicator material is (a), and the environmental exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

75. The direct thermal printer stock of claim 69, wherein the threshold temperature is between 20 and 40° C.

76. (canceled)

77. (canceled)

78. (canceled)

79. The direct thermal printer stock of claim 69, wherein the print head is configured to heat at least a portion of the direct thermal paper stock to a heated thermal transfer temperature that is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

80. The direct thermal printer stock of claim 69, wherein the environmental exposure indicator material further comprises a leuco dye, a micro-encapsulated leuco-dye, an SCC Polymer, a water-based SCC polymer emulsion, a diacetylene, an alkane, a wax, an ester or combinations thereof.

81. (canceled)

82. (canceled)

83. The direct thermal printer stock of claim 69, wherein the environmental exposure indicator material has a concentration, in a layer applied to the direct thermal printer stock, in the range selected from the group consisting of about 10 to 60% ww, about 20 to 60% ww, about 25 to 60% ww, about 30 to 60% ww, about 35 to 60% ww, about 40 to 60% ww, about 30 to 60% ww, about 30 to 55% ww, about 30 to 50% ww, about 30 to 45% ww, about 40 to 55% ww, about 40 to 50% ww, and about 45 to 50% ww.

84. The direct thermal printer stock of claim 69, wherein the environmental exposure indicator material is (c) and the second lower temperature threshold is in the range selected from the group consisting of <4° C., <0° C., <−5° C., <−10° C. and <−15° C.

85. (canceled)

86. (canceled)

87. (canceled)

88. (canceled)

89. (canceled)

90. (canceled)

91. (canceled)

92. The direct thermal printer stock of claim 69, wherein the environmental exposure indicator material is provided on the thermal paper substrate as an SCC emulsion.

93. (canceled)

94. The direct thermal printer stock of claim 92, wherein the SCC emulsion is configured to change color state from opaque white to colorless above the threshold temperature of 40° C.

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. (canceled)

123. (canceled)

124. (canceled)

125. (canceled)

126. (canceled)

127. A direct thermal label, comprising:
a thermal paper substrate configured to be printed by a direct thermal print process with a heated thermal print head, the thermal paper substrate having a print temperature and adapted to change color when heated by the heated thermal print head to or above the print temperature;
a temperature exposure indicator provided on the thermal paper substrate, the temperature exposure indicator comprising the temperature exposure indicator material configured to change color state in response to a temperature exposure above a predetermined threshold temperature, which is below the print temperature; and
a dataform imaged on the thermal paper substrate at or above the print temperature without the temperature exposure indicator material changing color state.

128. The direct thermal label of claim 127, wherein the temperature exposure indicator material is a dye encapsulated in a matrix.

129. The direct thermal label of claim 127, wherein the temperature exposure indicator material is selected from the group consisting of:
(a) an irreversible thermochromic indicator material configured to change color state in response to a temperature above the threshold temperature;
(b) a reversible thermochromic indicator material configured to change color state in response to a temperature above the threshold temperature;
(c) a reversible thermochromic indicator material configured to change color state in response to a temperature below the threshold temperature;
(d) a semi-reversible thermochromic indicator material configured to change color state in response to a temperature above the threshold temperature, and to maintain the changed color state until the temperature falls below a second lower temperature threshold; and
(e) an irreversible thermochromic indicator material configured to change color state responsive to cumulative heat exposure over time.

130. (canceled)

131. The direct thermal label of claim 127, wherein the temperature exposure indicator is configured to reveal a barcode symbol in response to a temperature exposure above the predetermined threshold temperature.

132. The direct thermal label of claim 131, wherein the temperature exposure indicator is configured to mask the barcode symbol in response to a temperature exposure below the predetermined threshold temperature.

133. The direct thermal label of claim 132, wherein the temperature exposure indicator material is configured to change color state responsive to exposure to the temperature above the threshold temperature for a period that is in the range selected from the group consisting of about 30 seconds to 5 minutes, about 1 minute to 5 minutes, about 2 minute to 4 minutes, and about 2 minutes to 3 minutes.

134. The direct thermal label of claim 133, wherein the threshold temperature is in the range selected from the group consisting of about −20 to 70° C., about 30 to 70° C., about 30 to 50° C., about 40 to 50° C., 20 to 40° C., about 20 to 30° C., about 25 to 35° C., about 30 to 35° C., about 32.5 to 35° C., and about 34 to 36° C.

135. (canceled)

136. (canceled)

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)

159. (canceled)

160. (canceled)

161. (canceled)

162. (canceled)

163. (canceled)

164. (canceled)

165. (canceled)

166. (canceled)

167. (canceled)

168. (canceled)

169. (canceled)

170. (canceled)

171. (canceled)

172. (canceled)

173. (canceled)

174. (canceled)

175. (canceled)

176. (canceled)

177. (canceled)

178. (canceled)

179. (canceled)

180. (canceled)

181. (canceled)

182. (canceled)

183. (canceled)

184. (canceled)

185. (canceled)

186. (canceled)

187. (canceled)

188. (canceled)

189. (canceled)

190. (canceled)

191. (canceled)

192. (canceled)

193. (canceled)

194. (canceled)

195. (canceled)

196. (canceled)

197. A method of making temperature exposure indicator printing stock, comprising:
receiving a thermal paper stock; and
applying a thermochromic temperature indicator material to the thermal paper stock, the thermochromic temperature indicator material configured to change color state in response to reaching a temperature that is lower than the printing temperature of the thermal paper stock.

198. (canceled)

199. The method of claim 197, wherein the thermal paper stock is a direct thermal print paper containing a thermochromic pigment configured to change color when reaching the printing temperature.

200. The method of claim 197, wherein the printing temperature is in the range selected from the group consisting of about 150 to 300° C., about 175 to 275° C., about 200 to 250° C., about 210 to 250° C., about 220 to 250° C., about 230 to 250° C., about 240 to 250° C., about 210 to 240° C., about 210 to 230° C., and about 210 to 220° C.

201. The method of claim 197, wherein the temperature for the temperature indicator material is in the range selected from the group consisting of about 20 to 50° C., about 30 to 50° C., about 40 to 50° C., 20 to 40° C., about 20 to 30° C., about 25 to 35° C., about 30 to 35° C., about 32.5 to 35° C., and about 34 to 36° C.

202. The method of claim 197, wherein the temperature exposure indicator material is selected from the group consisting of:
(a) an irreversible thermochromic indicator material configured to change color state in response to a temperature above the threshold temperature;
(b) a reversible thermochromic indicator material configured to change color state in response to a temperature above the threshold temperature;
(c) a reversible thermochromic indicator material configured to change color state in response to a temperature below the threshold temperature;
(d) a semi-reversible thermochromic indicator material configured to change color state in response to a temperature above the threshold temperature, and to maintain the changed color state until the temperature falls below a second lower temperature threshold; and
(e) an irreversible thermochromic indicator material configured to change color state responsive to cumulative heat exposure over time.

203. (canceled)

204. A method of making a temperature exposure indicator comprising:
receiving a thermal paper stock having a thermochromic temperature indicator applied thereto, the thermochromic temperature indicator configured to change color state above a threshold temperature; and
printing on the thermal paper stock using a direct thermal print process through the thermochromic temperature indicator using a thermal print head causing portions of the thermal paper stock to reach a print temperature higher than the threshold temperature without triggering the change in color state of the thermochromic temperature indicator.

205. The method of claim 204, wherein the thermal paper stock includes a dye encapsulated in a matrix that is configured to change state when reaching the printing temperature.

206. The method of claim 204, wherein the temperature exposure indicator material is selected from the group consisting of:
(a) an irreversible thermochromic indicator material configured to change color state in response to a temperature above the threshold temperature;
(b) a reversible thermochromic indicator material configured to change color state in response to a temperature above the threshold temperature;
(c) a reversible thermochromic indicator material configured to change color state in response to a temperature below the threshold temperature;
(d) a semi-reversible thermochromic indicator material configured to change color state in response to a temperature above the threshold temperature, and to maintain the changed color state until the temperature falls below a second lower temperature threshold; and
(e) an irreversible thermochromic indicator material configured to change color state responsive to cumulative heat exposure over time.

207. (canceled)

208. (canceled)
